(19) United States
(12) Patent Application Publication
(10) Pub. No.: US 2025/0351171 A1
(43) Pub. Date: Nov. 13, 2025

(54) INDICATIONS FOR NON-PRIMARY CHANNEL ACCESS

(71) Applicant: QUALCOMM Incorporated, San Diego, CA (US)

(72) Inventors: Gaurang NAIK, San Diego, CA (US); Abhishek Pramod PATIL, San Diego, CA (US); George CHERIAN, San Diego, CA (US); Alfred ASTERJADHI, San Diego, CA (US); Sai Yiu Duncan HO, San Diego, CA (US); Sherief HELWA, San Diego, CA (US); Sanket Sanjay KALAMKAR, San Diego, CA (US); Giovanni CHISCI, San Diego, CA (US)

(21) Appl. No.: 18/658,012

(22) Filed: May 8, 2024

(51) Int. Cl. H04W 74/0816; H04W 74/06; H04W 74/08

(52) U.S. Cl. CPC H04W 74/0816; H04W 74/06; H04W 74/0866

(57) ABSTRACT

This disclosure provides methods, components, devices and systems for indications for non-primary channel access. Various aspects relate generally to communicating an indication relating to a wireless device or signaling (such as a physical layer (PHY) protocol data unit (PPDU)) from an OBSS. Sharing the indication between wireless devices may facilitate non-primary channel access (NPCA). Some aspects more specifically relate to a first wireless device that may receive a portion of a PPDU communicated by a third wireless device in an OBSS. The portion of the PPDU may indicate that the third wireless device is included in the OBSS. The first wireless device may transmit a frame including an indication to a second wireless device. The first wireless device and the second wireless device may be included in a BSS and may utilize the indication to perform NPCA on an opportunistic primary channel.

### TECHNICAL FIELD

This disclosure relates generally to wireless communication and, more specifically, to indications for non-primary channel access.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

Some wireless communication networks may operate in accordance with procedures for allocating or contending for communication resources. However, these procedures may fail to utilize available communication resources, which may result in wasted resources or increased latency.

### SUMMARY

The systems, methods, and devices of this disclosure each have several innovative aspects, no single one of which is solely responsible for the desirable attributes disclosed herein.

One innovation aspect of the subject matter described in this disclosure can be implemented in a method for wireless communication by a first wireless device. The method may include receiving, from a second wireless device capable of non-primary channel access (NPCA), a first frame soliciting an indication associated with at least one wireless device in an overlapping basic service set (OBSS) different from a basic service set (BSS) that includes at least one of the first wireless device and the second wireless device, the first wireless device being capable of NPCA, receiving a portion of a physical layer (PHY) protocol data unit (PPDU) communicated by a third wireless device, the portion of the PPDU indicating that the third wireless device is included in the OBSS, and transmitting, to the second wireless device, a second frame including the indication, the indication being associated with the portion of the PPDU.

Another innovation aspect of the subject matter described in this disclosure can be implemented in an apparatus for wireless communication at a first wireless device. The first wireless device may include a processing system that includes processor circuitry and memory circuitry that stores code. The processing system may be configured to cause the first wireless device to receive, from a second wireless device capable of NPCA, a first frame soliciting an indication associated with at least one wireless device in an OBSS different from a BSS that includes at least one of the first wireless device and the second wireless device, the first wireless device being capable of NPCA, receive a portion of a PPDU communicated by a third wireless device, the portion of the PPDU indicating that the third wireless device is included in the OBSS, and transmit, to the second wireless device, a second frame including the indication, the indication being associated with the portion of the PPDU.

Another innovation aspect of the subject matter described in this disclosure can be implemented in another apparatus for wireless communication at a first wireless device. The first wireless device may include means for receiving, from a second wireless device capable of NPCA, a first frame soliciting an indication associated with at least one wireless device in an OBSS different from a BSS that includes at least one of the first wireless device and the second wireless device, the first wireless device being capable of NPCA, means for receiving a portion of a PPDU communicated by a third wireless device, the portion of the PPDU indicating that the third wireless device is included in the OBSS, and means for transmitting, to the second wireless device, a second frame including the indication, the indication being associated with the portion of the PPDU.

Another innovation aspect of the subject matter described in this disclosure can be implemented in a non-transitory computer-readable medium storing code for wireless communication. The code may include instructions executable by one or more processors to receive, from a second wireless device capable of NPCA, a first frame soliciting an indication associated with at least one wireless device in an OBSS different from a BSS that includes at least one of the first wireless device and the second wireless device, the first wireless device being capable of NPCA, receive a portion of a PPDU communicated by a third wireless device, the portion of the PPDU indicating that the third wireless device is included in the OBSS, and transmit, to the second wireless device, a second frame including the indication, the indication being associated with the portion of the PPDU.

In some examples of the method, devices, and non-transitory computer-readable medium described herein, transmitting the second frame including the indication may include operations, features, means, or instructions for transmitting the second frame including the indication via a first channel in which the PPDU may be received or via a second channel different from the first channel.

In some examples of the method, devices, and non-transitory computer-readable medium described herein, transmitting the second frame including the indication may include operations, features, means, or instructions for transmitting the second frame including the indication via a second link that may be different from a first link via which the PPDU may be received, the first wireless device being a first multi-link device (MLD) and the second wireless device being a second MLD.

In some examples of the method, devices, and non-transitory computer-readable medium described herein, transmitting the second frame including the indication may include operations, features, means, or instructions for transmitting the second frame including the indication during a communication of the third wireless device, the communication being associated with the PPDU.

In some examples of the method, devices, and non-transitory computer-readable medium described herein, transmitting the second frame may include operations, features, means, or instructions for transmitting the second frame for at least one of: a time solicited by the second wireless device, each time a new OBSS PPDU is detected by the first wireless device in a range from the first wireless device, or a periodic time.

In some examples of the method, devices, and non-transitory computer-readable medium described herein, the indication may be limited to one or more wireless devices that communicated one or more respective PPDUs within a time window, including the PPDU communicated by the third wireless device.

In some examples of the method, devices, and non-transitory computer-readable medium described herein, the indication may be limited to a type of PPDU, the type of PPDU including the PPDU communicated by the third wireless device.

In some examples of the method, devices, and non-transitory computer-readable medium described herein, the first frame, the second frame, or a combination thereof indicates the type of PPDU.

In some examples of the method, devices, and non-transitory computer-readable medium described herein, a type of PPDU, including the PPDU communicated by the third wireless device, may be associated with a capability of the first wireless device, an operation mode of the first wireless device, or a combination thereof.

In some examples of the method, devices, and non-transitory computer-readable medium described herein, the indication includes a binary value or a non-binary value associated with a measurement of a signal indicating the PPDU, the binary value or the non-binary value being indicated in the first frame, the second frame, or a combination thereof.

In some examples of the method, devices, and non-transitory computer-readable medium described herein, a null data packet (NDP) feedback report poll (NFRP) trigger frame or a NFRP-like trigger frame variant may be used as the first frame, and the method, devices, and non-transitory computer-readable medium described herein may further include operations, features, means, or instructions for transmitting the second frame if an association identifier (AID) value of the first wireless device is within an AID range.

Some examples of the method, devices, and non-transitory computer-readable medium described herein may further include operations, features, means, or instructions for communicating, with the second wireless device, a mapping between a medium access control (MAC) identifier and a second identifier of the third wireless device, the second identifier being shorter than the MAC identifier, the second identifier of the third wireless device being included in the first frame, the second frame, or a combination thereof.

In some examples of the method, devices, and non-transitory computer-readable medium described herein, the first wireless device may be a non-access point (AP) station (STA), the second wireless device may be an AP that assigns an AID value to the first wireless device in association with the first wireless device being capable of NPCA, and the first frame may be a trigger frame indicating a starting AID value and an AID range, the second frame being transmitted in association with the first wireless device having an AID value within the AID range.

In some examples of the method, devices, and non-transitory computer-readable medium described herein, the first frame soliciting the indication includes one or more identifiers, at least one of the one or more identifiers being associated with the third wireless device or the PPDU, and the indication being associated with at least one of the one or more identifiers.

In some examples of the method, devices, and non-transitory computer-readable medium described herein, the first frame soliciting the indication may be received during a communication associated with the PPDU for identification of the third wireless device or the PPDU.

In some examples of the method, devices, and non-transitory computer-readable medium described herein, the first frame soliciting the indication may be addressed to a group of wireless devices including the first wireless device.

In some examples of the method, devices, and non-transitory computer-readable medium described herein, receiving the portion of the PPDU may include operations, features, means, or instructions for receiving multiple PPDUs associated with respective third wireless devices, the indication identifying each of the respective third wireless devices.

Another innovation aspect of the subject matter described in this disclosure can be implemented in a method for wireless communication by a second wireless device is described. The method may include transmitting, to a first wireless device capable of NPCA, a first frame soliciting an indication associated with at least one wireless device in an OBSS different from a BSS that includes at least one of the first wireless device and the second wireless device, the second wireless device being capable of NPCA and receiving, from the first wireless device, a second frame including the indication, the indication being associated with a portion of a PPDU communicated by a third wireless device in the OBSS.

Another innovation aspect of the subject matter described in this disclosure can be implemented in an apparatus for wireless communication at a second wireless device is described. The second wireless device may include a processing system that includes processor circuitry and memory circuitry that stores code. The processing system may be configured to cause the second wireless device to transmit, to a first wireless device capable of NPCA, a first frame soliciting an indication associated with at least one wireless device in an OBSS different from a BSS that includes at least one of the first wireless device and the second wireless device, the second wireless device being capable of NPCA and receive, from the first wireless device, a second frame including the indication, the indication being associated with a portion of a PPDU communicated by a third wireless device in the OBSS.

Another innovation aspect of the subject matter described in this disclosure can be implemented in another apparatus for wireless communication at a second wireless device is described. The second wireless device may include means for transmitting, to a first wireless device capable of NPCA, a first frame soliciting an indication associated with at least one wireless device in an OBSS different from a BSS that includes at least one of the first wireless device and the second wireless device, the second wireless device being capable of NPCA and means for receiving, from the first wireless device, a second frame including the indication, the indication being associated with a portion of a PPDU communicated by a third wireless device in the OBSS.

Another innovation aspect of the subject matter described in this disclosure can be implemented in a non-transitory computer-readable medium storing code for wireless communication is described. The code may include instructions executable by one or more processors to transmit, to a first wireless device capable of NPCA, a first frame soliciting an indication associated with at least one wireless device in an OBSS different from a BSS that includes at least one of the first wireless device and the second wireless device, the second wireless device being capable of NPCA and receive, from the first wireless device, a second frame including the indication, the indication being associated with a portion of a PPDU communicated by a third wireless device in the OBSS.

In some examples of the method, devices, and non-transitory computer-readable medium described herein, receiving the second frame including the indication may include operations, features, means, or instructions for receiving the second frame including the indication via a first channel in which the PPDU may be transmitted or via a second channel different from the first channel.

In some examples of the method, devices, and non-transitory computer-readable medium described herein, receiving the second frame including the indication may include operations, features, means, or instructions for receiving the second frame including the indication via a second link that may be different from a first link via which the PPDU may be communicated, the first wireless device being a first MLD and the second wireless device being a second MLD.

Some examples of the method, devices, and non-transitory computer-readable medium described herein may further include operations, features, means, or instructions for transmitting a third frame soliciting another indication in association with a validity of the indication being limited to a time window.

In some examples of the method, devices, and non-transitory computer-readable medium described herein, the indication may be limited to a type of PPDU, the type of PPDU including the PPDU communicated by the third wireless device.

In some examples of the method, devices, and non-transitory computer-readable medium described herein, a type of PPDU, including the PPDU communicated by the third wireless device, may be associated with a capability of the first wireless device, an operation mode of the first wireless device, or a combination thereof.

In some examples of the method, devices, and non-transitory computer-readable medium described herein, the indication includes a binary value or a non-binary value associated with a measurement of a signal indicating the PPDU, the binary value or the non-binary value being indicated in the first frame, the second frame, or a combination thereof.

Some examples of the method, devices, and non-transitory computer-readable medium described herein may further include operations, features, means, or instructions for communicating, with the first wireless device, a mapping between a MAC identifier and a second identifier of the third wireless device, the second identifier being shorter than the MAC identifier, the second identifier of the third wireless device being included in the first frame, the second frame, or a combination thereof.

In some examples of the method, devices, and non-transitory computer-readable medium described herein, the first wireless device may be a non-AP STA, the second wireless device may be an AP that assigns an AID value to the first wireless device in association with the first wireless device being capable of NPCA, and the first frame may be a trigger frame indicating a starting AID value and an AID range, the second frame being transmitted in association with the first wireless device having an AID value within the AID range.

In some examples of the method, devices, and non-transitory computer-readable medium described herein, the first frame soliciting the indication may be transmitted during a communication associated with the PPDU for identification of the third wireless device or the PPDU.

Some examples of the method, devices, and non-transitory computer-readable medium described herein may further include operations, features, means, or instructions for communicating, in association with the second frame including the indication, with the first wireless device via a second channel that may be different from a first channel in which the PPDU may be transmitted.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram illustrating examples of links between wireless devices in a wireless communication network.

FIG. 2 shows an example physical layer (PHY) protocol data unit (PPDU) usable for communications between a wireless AP and one or more wireless STAs.

FIG. 3 shows a hierarchical format of an example PPDU usable for communications between a wireless AP and one or more wireless STAs.

FIG. 4 is a block diagram illustrating examples of wireless devices in a wireless communication system that supports indications for non-primary channel access (NPCA).

FIG. 5 is a timing diagram illustrating examples of scenarios with successful NPCA and unsuccessful NPCA.

FIG. 6 is a timing diagram illustrating an example of a solicited indication for NPCA.

FIG. 7 is a timing diagram illustrating an example of a solicited indication with different channels that supports indications for NPCA.

FIG. 8 is a timing diagram illustrating an example of a solicited indication, where a frame carrying the indication provides information for overlapping basic service set (OBSS) stations (STAs).

FIG. 9 is a timing diagram illustrating an example of an unsolicited indication, where a frame carrying the indication provides information for OBSS STAs.

FIG. 10 is a timing diagram illustrating an example of unsolicited indications following physical layer (PHY) protocol data units (PPDUs) of detected OBSS STAs.

FIG. 11 is a timing diagram illustrating an example of an unsolicited indication with different channels that supports indications for NPCA.

FIG. 12 is a timing diagram illustrating an example of a solicited indication with different links that supports indications for NPCA.

FIG. 13 is a timing diagram illustrating examples of unsolicited indications via frame exchanges and a null frame with different links that supports indications for NPCA.

FIG. 14 is a timing diagram illustrating examples of periodic unsolicited indications.

FIG. 15 shows an example of a process flow that supports indications for NPCA.

FIG. 16 is a block diagram illustrating an example of a first wireless device that supports indications for NPCA.

FIG. 17 is a block diagram illustrating an example of a second wireless device that supports indications for NPCA.

FIGS. 18 and 19 show flowcharts illustrating example processes performable by or at a first wireless device that supports indications for NPCA.

FIGS. 20 and 21 show flowcharts illustrating example processes performable by or at a second wireless device that supports indications for NPCA.

Like reference numbers and designations in the various drawings may indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

Some wireless communication systems utilize an established channel for control or data signaling. For example, IEEE 802.11be or Wi-Fi 7 may utilize one 20 megahertz (MHz) channel that is designated as a primary channel, while supporting a relatively large bandwidth (such as in extremely high throughput (EHT) specifications, which may have defined bandwidth support up to 320 MHz). As used herein, a “wireless device” may refer to an access point (AP), to a station (STA), to a non-AP STA, to an AP multi-link device (MLD), to a non-AP MLD, or to another wireless device. A wireless device may contend for access on the primary channel, where access to wider bandwidths is contingent on access to the primary channel. For example, a basic service set (BSS) may include wireless devices (such as an AP and non-AP stations (STAs)), where wireless devices may contend to access the primary channel. An overlapping basic service set (OBSS) may include one or more other wireless devices with signaling that is within a detectable range of one or more wireless devices of the BSS. If another wireless device in an OBSS occupies the primary channel, a remainder of the wider bandwidth may remain unutilized, which may contribute to lower throughput and longer latencies.

A baseline channel for accessing a wireless communication system may be referred to as a primary channel, main channel, or main primary channel (M-Primary). An additional channel for accessing the wireless communication system may be referred to as an auxiliary primary channel, anchor channel, non-primary channel access (NPCA) primary channel, opportunistic channel, or opportunistic primary channel (O-Primary). An O-Primary channel may be utilized to for similar signaling as an M-Primary channel, such as when the M-Primary channel is occupied. NPCA is a capability where a wireless device (such as an ultra-high reliability (UHR) device) may be capable of monitoring one or more channels (such as 20 MHz O-Primary channel(s)) in addition to the M-Primary channel within an operating bandwidth. In some examples, a wireless device may monitor the O-Primary channel sequentially or in parallel.

In sequential monitoring, a wireless device (such as an NPCA-capable STA) may be capable of monitoring one channel at a time. In an example, the wireless device may monitor or contend on the M-Primary channel. When another wireless device in an OBSS is detected on the M-Primary channel, the wireless device may switch to an O-Primary channel for monitoring or contention.

In parallel monitoring, a wireless device (such as an NPCA-capable STA) may be capable of monitoring or contending on multiple channels (such as the M-Primary channel and one or more O-Primary channels) concurrently. In some examples, the wireless device may detect physical layer (PHY) protocol data units (PPDUs) on multiple channels concurrently, but may transmit or receive on one channel at a time.

In some approaches, when a wireless device (such as an NPCA-capable AP) detects OBSS traffic on the M-Primary channel, the wireless device may exchange frames with an associated peer wireless device (such as non-AP STA) on an O-Primary channel if the peer wireless device also detects the traffic on the M-Primary channel, and if the peer wireless device is capable of inferring that the traffic on the M-Primary channel is from another wireless device in an OBSS. However, detection of traffic may depend on the wireless devices' relative locations. It is possible that for some OBSS traffic, one peer may detect the traffic for another wireless device in an OBSS, but another peer may not detect the traffic. Mobility of wireless devices (such as an NPCA peer or a wireless device in an OBSS, among other examples) also may have an impact. Determining that the traffic on the M-Primary channel is associated with an OBSS may depend on a peer wireless device's capabilities.

In some examples, one or more wireless communication systems may experience asymmetric signaling on a primary channel (such as an M-Primary channel). For example, an AP x may provide network access to STA x1 and STA x2, an AP y may provide network access to STA y1, and an AP z may provide network access to STA z1, where STA z1 is within a coverage area of AP z (but not of AP x or AP y), STA x2 is within a coverage area of AP x and a coverage area of AP z (but not of AP y), STA x1 is within the coverage area of AP x and a coverage area of AP y (but not of AP z), and STA y1 is within the coverage area of AP y and the coverage area of AP x. AP x and AP z may be within the coverage area of AP y, AP z (but not AP y) may be within the coverage area of AP x, and AP x (but not AP y) may be within the coverage area of AP z. When AP z occupies the M-Primary channel, AP x may communicate with STA x1 or STA x2 on an O-Primary channel. However, if STA y1 occupies the M-Primary channel, AP x may communicate with STA x1 on the O-Primary channel but may not communicate with STA x2. Or, when AP y occupies the M-Primary channel, even though STA x1 sees the M-Primary as busy, AP y may not communicate with AP x on the O-Primary channel. Such differences in views of the M-Primary channel may lead to lack of determinism in NPCA with a consequent performance loss.

In some examples, due to a wireless device's mode of operation, the wireless device may have the ability to detect a PPDU, but may not infer whether the PPDU is associated with an OBSS. For example, in an enhanced multi-link single-radio (eMLSR) mode, a wireless device (such as non-AP STA) may decode non-HT PPDUs (such as non-HT PPDUs or non-HT duplicate PPDUs), but may not decode other PPDUs (such as HT, very high throughput (VHT), high efficiency (HE), EHT PPDUs, or UHR PPDUs). One or more of the foregoing issues may cause a lack of determinism in NPCA operation. For instance, when an AP sends an initial control frame (ICF) on an opportunistic channel, a non-AP STA may not respond. The AP may thereafter move to other non-AP STAs, but the timeout interval may be wasted. As a result, NPCA performance may suffer.

Although some aspects of the present disclosure are described in the context of NPCA, with an M-Primary channel and one or more O-Primary channels, some of the concepts or techniques described herein may apply to any type of system with different types of channels or links used to contend for channel access. In some implementations, the techniques described herein may be applied in systems where the M-primary channel and the O-primary channel are sub-channels within an operating bandwidth (such as in NPCA). In some other implementations, some the techniques described herein may be applied where the M-primary channel and the O-primary channel are different links (such as in enhanced multi-link single radio (eMLSR) AP systems).

Various aspects relate generally to communicating an indication relating to a wireless device or signaling (such as a PPDU) from an OBSS. Sharing the indication between wireless devices may facilitate NPCA. For instance, a wireless device that may have not detected a PPDU from an OBSS on an M-Primary channel may utilize the indication to switch to an O-Primary channel to communicate with another wireless device.

Some aspects more specifically relate to a first wireless device that may receive a portion of a PPDU communicated by a third wireless device in an OBSS. The portion of the PPDU may indicate that the third wireless device is included in the OBSS. The first wireless device may transmit a frame including an indication to a second wireless device. The indication may be associated with the portion of the PPDU. The first wireless device and the second wireless device may be included in a BSS and may utilize the indication to perform NPCA on an O-Primary channel.

Particular aspects of the subject matter described in this disclosure can be implemented to realize one or more of the following potential advantages. In some examples, by communicating the indication, the described techniques can be utilized to indicate OBSS activity, which may be utilized to perform or coordinate NPCA. For instance, a second wireless device that did not detect an OBSS PPDU may utilize the indication to switch to an O-Primary channel for communication with another wireless device, which may utilize available resources (such as the O-Primary channel or additional bandwidth) to communicate. Utilizing the indication may reduce wasted resources, increase throughput, or reduce communication delay.

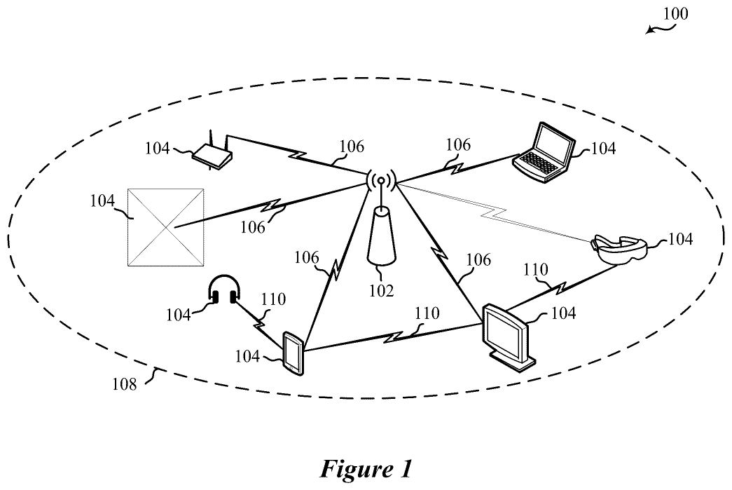

FIG. 1 shows a pictorial diagram illustrating examples of links 106 between wireless devices in a wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless devices including a wireless AP 102 and any number of wireless STAs 104. While only one AP 102 is shown in FIG. 1, the wireless communication network 100 can include multiple APs 102 (such as in an extended service set (ESS) deployment, enterprise network or AP mesh network), or may not include any AP at all (such as in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP MLD), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IOT) devices, and vehicles, among other examples.

A single AP 102 and an associated set of STAs 104 may be referred to as an infrastructure BSS, which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4(52.6 GHz-114.25 GHz), and FR5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (such as a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (such as for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting UHR communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as an M-Primary channel and one or more additional, second primary channels may each be referred to as an O-Primary channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (such as UHR-or IEEE 802.11bn-compatible) devices for opportunistic access to spectrum that may be otherwise under-utilized.

The AP 102 and the STAs 104 of the wireless communication network 100 may implement technologies, protocols or procedures compliant with current and future generations of the IEEE 802.11 family of wireless communication protocol standards, such as EHT operation defined by the IEEE 802.11be standard amendment and UHR operation defined by the IEEE 802.11bn standard amendments, to enable additional capabilities or features relative to previous generations, such as devices supporting only legacy operation such as VHT operation defined by the 802.11ac standard amendment or HE operation defined by the IEEE 802.11ax standard amendment. For example, the IEEE 802.11be standard amendment introduced 320 MHz channels, which are twice as wide as those possible with the IEEE 802.11ax standard amendment. Accordingly, the AP 102 or the STAs 104 may use 320 MHz channels enabling double the throughput and network capacity, as well as providing rate versus range gains at high data rates due to linear bandwidth versus log SNR trade-off. EHT, UHR or other newer wireless communication protocols may support flexible operating bandwidth enhancements, such as broadened operating bandwidths relative to legacy operating bandwidths or more granular operation relative to legacy operation. For example, an EHT system may allow communications spanning operating bandwidths of 20 MHz, 40 MHz, 80 MHz, 160 MHz, 240 MHz, and 320 MHz while an UHR system may enable communications spanning even greater bandwidths, such as 480 MHz, 640 MHz or greater. EHT systems may, for example, support multiple bandwidth modes such as a contiguous 240 MHz bandwidth mode, a contiguous 320 MHz bandwidth mode, a noncontiguous 160+160 MHz bandwidth mode, or a noncontiguous 80+80+80+80 (or “4×80”) MHz bandwidth mode.

In some examples in which a wireless communication device (such as the AP 102 or the STA 104) operates in a contiguous 320 MHz bandwidth mode or a 160+160 MHz bandwidth mode, signals for transmission may be generated by two different transmit chains of the wireless communication device each having or associated with a bandwidth of 160 MHz (and each coupled to a different power amplifier). In some other examples, two transmit chains can be used to support a 240 MHz/160+80 MHz bandwidth mode by puncturing 320 MHz/160+160 MHz bandwidth modes with one or more 80 MHz subchannels. For example, signals for transmission may be generated by two different transmit chains of the wireless communication device each having a bandwidth of 160 MHz with one of the transmit chains outputting a signal having an 80 MHz subchannel punctured therein. In some other examples in which the wireless communication device may operate in a contiguous 240 MHz bandwidth mode, or a noncontiguous 160+80 MHz bandwidth mode, the signals for transmission may be generated by three different transmit chains of the wireless communication device, each having a bandwidth of 80 MHz. In some other examples, signals for transmission may be generated by four or more different transmit chains of the wireless communication device, each having a bandwidth of 80 MHz.

In noncontiguous examples, the operating bandwidth may span one or more disparate sub-channel sets. For example, the 320 MHz bandwidth may be contiguous and located in the same 6 GHz band or noncontiguous and located in different bands or regions within a band (such as partly in the 5 GHz band and partly in the 6 GHz band).

In some examples, the AP 102 or the STA 104 may benefit from operability enhancements associated with EHT, UHR and newer generations of the IEEE 802.11 family of wireless communication protocol standards. For example, the AP 102 or the STA 104 attempting to gain access to the wireless medium of the wireless communication network 100 may perform techniques (which may include modifications to existing rules, structure, or signaling implemented for legacy systems) such as clear channel assessment (CCA) operation based on EHT or UHR enhancements such as increased bandwidth, puncturing, or refinements to carrier sensing and signal reporting mechanisms.

In some examples, the AP 102 or one or more STAs 104 may share one or more indications relating to signaling (such as a PPDU) or another wireless device(s) in an OBSS. For instance, a STA 104 may receive a portion of a PPDU from another wireless device in an OBSS. The STA 104 may transmit an indication of the PPDU or the wireless device to the AP 102. The STA 104 or the AP 102 may utilize the indication to perform NPCA. For instance, the portion of the PPDU from the other wireless device in the OBSS may be transmitted in the M-Primary channel. The STA 104 may transmit the indication to the AP 102, where the AP 102 or the STA 104 may switch to an O-Primary channel to communicate.

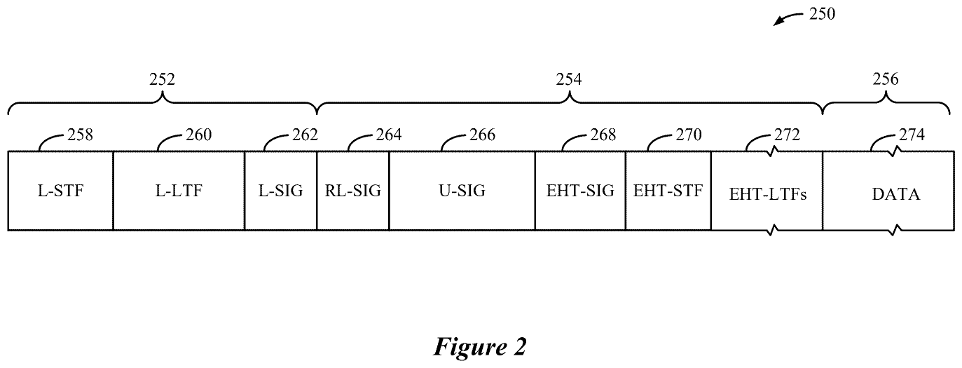

FIG. 2 shows an example PPDU 250 usable for communications between a wireless AP and one or more wireless STAs. For example, the AP and STAs may be examples of the AP 102 and the STAs 104 described with reference to FIG. 1. As shown, the PPDU 250 includes a PHY preamble, that includes a legacy portion 252 and a non-legacy portion 254, and a payload 256 that includes a data field 274. The legacy portion 252 of the preamble includes an L-STF 258, an L-LTF 260, and an L-SIG 262. The non-legacy portion 254 of the preamble includes a repetition of L-SIG (RL-SIG) 264 and multiple wireless communication protocol version-dependent signal fields after RL-SIG 264. For example, the non-legacy portion 254 may include a universal signal field 266 (referred to herein as “U-SIG 266”) and an EHT signal field 268 (referred to herein as “EHT-SIG 268”). The presence of RL-SIG 264 and U-SIG 266 may indicate to EHT-or later version-compliant STAs 104 that the PPDU 250 is an EHT PPDU or a PPDU conforming to any later (post-EHT) version of a new wireless communication protocol conforming to a future IEEE 802.11 wireless communication protocol standard. One or both of U-SIG 266 and EHT-SIG 268 may be structured as, and carry version-dependent information for, other wireless communication protocol versions associated with amendments to the IEEE family of standards beyond EHT. For example, U-SIG 266 may be used by a receiving device (such as an AP 102 or a STA 104) to interpret bits in one or more of EHT-SIG 268 or the data field 274. Like L-STF 258, L-LTF 260, and L-SIG 262, the information in U-SIG 266 and EHT-SIG 268 may be duplicated and transmitted in each of the component 20 MHz channels in instances involving the use of a bonded channel.

The non-legacy portion 254 further includes an additional short training field 270 (referred to herein as “EHT-STF 270,” although it may be structured as, and carry version-dependent information for, other wireless communication protocol versions beyond EHT) and one or more additional long training fields 272 (referred to herein as “EHT-LTFs 272,” although they may be structured as, and carry version-dependent information for, other wireless communication protocol versions beyond EHT). EHT-STF 270 may be used for timing and frequency tracking and AGC, and EHT-LTF 272 may be used for more refined channel estimation.

EHT-SIG 268 may be used by an AP 102 to identify and inform one or multiple STAs 104 that the AP 102 has scheduled uplink (UL) or downlink (DL) resources for them. EHT-SIG 268 may be decoded by each compatible STA 104 served by the AP 102. EHT-SIG 268 may generally be used by the receiving device to interpret bits in the data field 274. For example, EHT-SIG 268 may include resource unit (RU) allocation information, spatial stream configuration information, and per-user (such as STA-specific) signaling information. Each EHT-SIG 268 may include a common field and at least one user-specific field. In the context of OFDMA, the common field can indicate RU distributions to multiple STAs 104, indicate the RU assignments in the frequency domain, indicate which RUs are allocated for MU-MIMO transmissions and which RUs correspond to OFDMA transmissions, and the number of users in allocations, among other examples. The user-specific fields are assigned to particular STAs 104 and carry STA-specific scheduling information such as user-specific MCS values and user-specific RU allocation information. Such information enables the respective STAs 104 to identify and decode corresponding RUs in the associated data field 274.

In some examples, a wireless device (such as an AP 102 or a STA 104) may utilize a PHY or MAC header of the PPDU 250 to determine that the PPDU 250 originated from an OBSS. The wireless device may utilize the PHY or MAC header to generate or transmit an indication of the PPDU 250 to another wireless device, which may be utilized to perform NPCA.

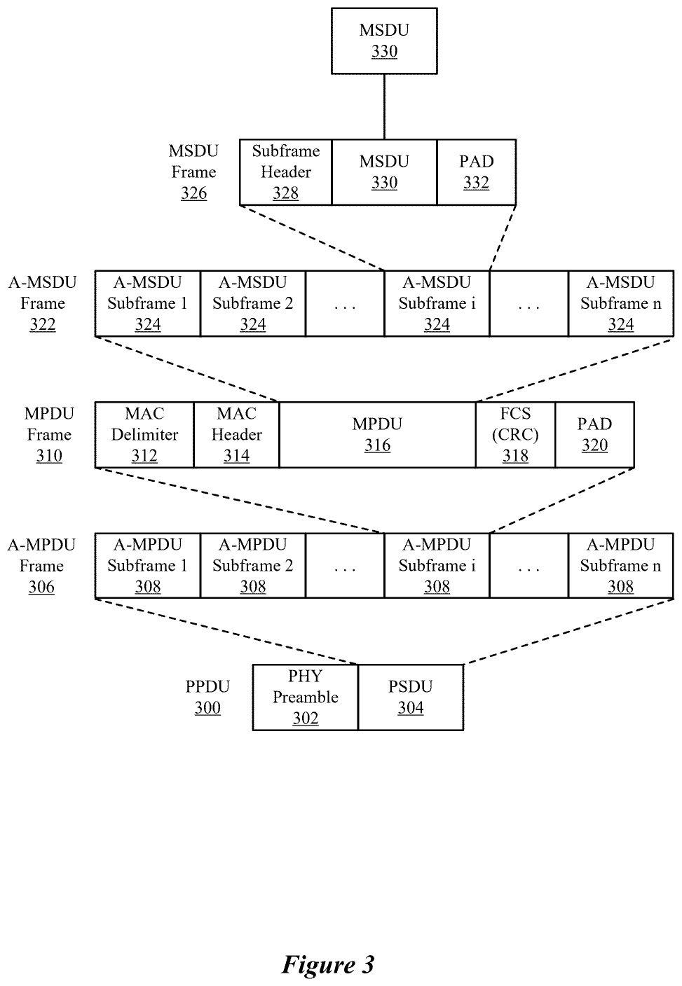

FIG. 3 shows a hierarchical format of an example PPDU usable for communications between a wireless AP and one or more wireless STAs. For example, the AP and STAs may be examples of the AP 102 and the STAs 104 described with reference to FIG. 1. As described, each PPDU 300 includes a PHY preamble 302 and a PSDU 304. Each PSDU 304 may represent (or “carry”) one or more MAC protocol data units (MPDUs) 316. For example, each PSDU 304 may carry an aggregated MPDU (A-MPDU) 306 that includes an aggregation of multiple A-MPDU subframes 308. Each A-MPDU subframe 308 may include an MPDU frame 310 that includes a MAC delimiter 312 and a MAC header 314 prior to the accompanying MPDU 316, which includes the data portion (“payload” or “frame body”) of the MPDU frame 310. Each MPDU frame 310 also may include a frame check sequence (FCS) field 318 for error detection (such as the FCS field 318 may include a cyclic redundancy check (CRC)) and padding bits 320. The MPDU 316 may carry one or more MAC service data units (MSDUs) 330. For example, the MPDU 316 may carry an aggregated MSDU (A-MSDU) 322 including multiple A-MSDU subframes 324. Each A-MSDU subframe 324 may be associated with an MSDU frame 326 and may contain a corresponding MSDU 330 preceded by a subframe header 328 and, in some examples, followed by padding bits 332.

Referring back to the MPDU frame 310, the MAC delimiter 312 may serve as a marker of the start of the associated MPDU 316 and indicate the length of the associated MPDU 316. The MAC header 314 may include multiple fields containing information that defines or indicates characteristics or attributes of data encapsulated within the frame body. The MAC header 314 includes a duration field indicating a duration extending from the end of the PPDU until at least the end of an acknowledgment (ACK) or Block ACK (BA) of the PPDU that is to be transmitted by the receiving wireless communication device. The use of the duration field serves to reserve the wireless medium for the indicated duration and enables the receiving device to establish its network allocation vector (NAV). The MAC header 314 also includes one or more fields indicating addresses for the data encapsulated within the frame body. For example, the MAC header 314 may include a combination of a source address, a transmitter address, a receiver address or a destination address. The MAC header 314 may further include a frame control field containing control information. The frame control field may specify a frame type, for example, a data frame, a control frame, or a management frame.

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (such as by generating a message integrity check (MIC) for one or more relevant fields.

Access to the shared wireless medium is generally governed by a distributed coordination function (DCF). With a DCF, there is generally no centralized master device allocating time and frequency resources of the shared wireless medium. On the contrary, before a wireless communication device, such as an AP 102 or a STA 104, is permitted to transmit data, it may wait for a particular time and contend for access to the wireless medium. The DCF is implemented through the use of time intervals (including the slot time (or “slot interval”) and the inter-frame space (IFS). IFS provides priority access for control frames used for proper network operation. Transmissions may begin at slot boundaries. Different varieties of IFS exist including the short IFS (SIFS), the distributed IFS (DIFS), the extended IFS (EIFS), and the arbitration IFS (AIFS). The values for the slot time and IFS may be provided by a suitable standard specification, such as one or more of the IEEE 802.11 family of wireless communication protocol standards.

In some examples, the wireless communication device (such as the AP 102 or the STA 104) may implement the DCF through the use of carrier sense multiple access (CSMA) with collision avoidance (CA) (CSMA/CA) techniques. According to such techniques, before transmitting data, the wireless communication device may perform a clear channel assessment (CCA) and may determine (such as identify, detect, ascertain, calculate, or compute) that the relevant wireless channel is idle. The CCA includes both physical (PHY-level) carrier sensing and virtual (MAC-level) carrier sensing. Physical carrier sensing is accomplished via a measurement of the received signal strength of a valid frame, which is compared to a threshold to determine (such as identify, detect, ascertain, calculate, or compute) whether the channel is busy. For example, if the received signal strength of a detected preamble is above a threshold, the medium is considered busy. Physical carrier sensing also includes energy detection. Energy detection involves measuring the total energy the wireless communication device receives regardless of whether the received signal represents a valid frame. If the total energy detected is above a threshold, the medium is considered busy.

Virtual carrier sensing is accomplished via the use of a network allocation vector (NAV), which effectively serves as a time duration that elapses before the wireless communication device may contend for access even in the absence of a detected symbol or even if the detected energy is below the relevant threshold. The NAV is reset each time a valid frame is received that is not addressed to the wireless communication device. When the NAV reaches 0, the wireless communication device performs the physical carrier sensing. If the channel remains idle for the appropriate IFS, the wireless communication device initiates a backoff timer, which represents a duration of time that the device senses the medium to be idle before it is permitted to transmit. If the channel remains idle until the backoff timer expires, the wireless communication device becomes the holder (or “owner”) of a transmit opportunity (TXOP) and may begin transmitting. The TXOP is the duration of time the wireless communication device can transmit frames over the channel after it has “won” contention for the wireless medium. The TXOP duration may be indicated in the U-SIG field of a PPDU. If, on the other hand, one or more of the carrier sense mechanisms indicate that the channel is busy, a MAC controller within the wireless communication device will not permit transmission.

Each time the wireless communication device generates a new PPDU for transmission in a new TXOP, it randomly selects a new backoff timer duration. The available distribution of the numbers that may be randomly selected for the backoff timer is referred to as the contention window (CW). There are different CW and TXOP durations for each of the four access categories (ACs): voice (AC_VO), video (AC_VI), background (AC_BK), and best effort (AC_BE). This enables particular types of traffic to be prioritized in the network.

In some other examples, the wireless communication device (such as the AP 102 or the STA 104) may contend for access to the wireless medium of a WLAN in accordance with an enhanced distributed channel access (EDCA) procedure. A random channel access mechanism such as EDCA may afford high-priority traffic a greater likelihood of gaining medium access than low-priority traffic. The wireless communication device using EDCA may classify data into different access categories. Each AC may be associated with a different priority level and may be assigned a different range of random backoffs (RBOs) so that higher priority data is more likely to win a TXOP than lower priority data (such as by assigning lower RBOs to higher priority data and assigning higher RBOs to lower priority data). Although EDCA increases the likelihood that low-latency data traffic will gain access to a shared wireless medium during a given contention period, unpredictable outcomes of medium access contention operations may prevent low-latency applications from achieving certain levels of throughput or satisfying certain latency requirements.

Some APs and STAs (such as the AP 102 and the STAs 104 described with reference to FIG. 1) may implement spatial reuse techniques. For example, APs 102 and STAs 104 configured for communications using the protocols defined in the IEEE 802.11ax or 802.11be standard amendments may be configured with a BSS color. APs 102 associated with different BSSs may be associated with different BSS colors. A BSS color is a numerical identifier of an AP 102's respective BSS (such as a 6 bit field carried by the SIG field). Each STA 104 may learn its own BSS color upon association with the respective AP 102. BSS color information is communicated at both the PHY and MAC sublayers. If an AP 102 or a STA 104 detects, obtains, selects, or identifies, a wireless packet from another wireless communication device while contending for access, the AP 102 or the STA 104 may apply different contention parameters in accordance with whether the wireless packet is transmitted by, or transmitted to, another wireless communication device (such another AP 102 or STA 104) within its BSS or from a wireless communication device from an overlapping BSS (OBSS), as determined, identified, ascertained, or calculated by a BSS color indication in a preamble of the wireless packet. For example, if the BSS color associated with the wireless packet is the same as the BSS color of the AP 102 or STA 104, the AP 102 or STA 104 may use a first RSSI detection threshold when performing a CCA on the wireless channel. However, if the BSS color associated with the wireless packet is different than the BSS color of the AP 102 or STA 104, the AP 102 or STA 104 may use a second RSSI detection threshold in lieu of using the first RSSI detection threshold when performing the CCA on the wireless channel, the second RSSI detection threshold being greater than the first RSSI detection threshold. In this way, the criteria for winning contention are relaxed when interfering transmissions are associated with an OBSS.

Some APs and STAs (such as the AP 102 and the STAs 104 described with reference to FIG. 1) may implement techniques for spatial reuse that involve participation in a coordinated communication scheme. According to such techniques, an AP 102 may contend for access to a wireless medium to obtain control of the medium for a TXOP. The AP that wins the contention (hereinafter also referred to as a “sharing AP”) may select one or more other APs (hereinafter also referred to as “shared APs”) to share resources of the TXOP. The sharing and shared APs may be located in proximity to one another such that at least some of their wireless coverage areas at least partially overlap. Some examples may specifically involve coordinated AP TDMA or OFDMA techniques for sharing the time or frequency resources of a TXOP. To share its time or frequency resources, the sharing AP may partition the TXOP into multiple time segments or frequency segments each including respective time or frequency resources representing a portion of the TXOP. The sharing AP may allocate the time or frequency segments to itself or to one or more of the shared APs. For example, each shared AP may utilize a partial TXOP assigned by the sharing AP for its uplink or downlink communications with its associated STAs.

In some examples of such TDMA techniques, each portion of a plurality of portions of the TXOP includes a set of time resources that do not overlap with any time resources of any other portion of the plurality of portions of the TXOP. In such examples, the scheduling information may include an indication of time resources, of multiple time resources of the TXOP, associated with each portion of the TXOP. For example, the scheduling information may include an indication of a time segment of the TXOP such as an indication of one or more slots or sets of symbol periods associated with each portion of the TXOP such as for multi-user TDMA.

In some examples of OFDMA techniques, each portion of the plurality of portions of the TXOP includes a set of frequency resources that do not overlap with any frequency resources of any other portion of the plurality of portions. In such examples, the scheduling information may include an indication of frequency resources, of multiple frequency resources of the TXOP, associated with each portion of the TXOP. For example, the scheduling information may include an indication of a bandwidth portion of the wireless channel such as an indication of one or more subchannels or resource units associated with each portion of the TXOP such as for multi-user OFDMA.

In this manner, the sharing AP's acquisition of the TXOP enables communication between one or more additional shared APs and their respective BSSs, subject to appropriate power control and link adaptation. For example, the sharing AP may limit the transmit powers of the selected shared APs such that interference from the selected APs does not prevent STAs associated with the TXOP owner from successfully decoding packets transmitted by the sharing AP. Such techniques may be used to reduce latency because the other APs may not need to wait to win contention for a TXOP to be able to transmit and receive data according to conventional CSMA/CA or enhanced distributed channel access (EDCA) techniques. Additionally, by enabling a group of APs 102 associated with different BSSs to participate in a coordinated AP transmission session, during which the group of APs may share at least a portion of a single TXOP obtained by any one of the participating APs, such techniques may increase throughput across the BSSs associated with the participating APs and also may achieve improvements in throughput fairness. Furthermore, with appropriate selection of the shared APs and the scheduling of their respective time or frequency resources, medium utilization may be maximized or otherwise increased while packet loss resulting from OBSS interference is minimized or otherwise reduced. Various implementations may achieve these and other advantages without requiring that the sharing AP or the shared APs be aware of the STAs 104 associated with other BSSs, without requiring a preassigned or dedicated master AP or preassigned groups of APs, and without requiring backhaul coordination between the APs participating in the TXOP.

In some examples in which the signal strengths or levels of interference associated with the selected APs are relatively low (such as less than a given value), or when the decoding error rates of the selected APs are relatively low (such as less than a threshold), the start times of the communications among the different BSSs may be synchronous. Conversely, when the signal strengths or levels of interference associated with the selected APs are relatively high (such as greater than the given value), or when the decoding error rates of the selected APs are relatively high (such as greater than the threshold), the start times may be offset from one another by a time period associated with decoding the preamble of a wireless packet and determining, from the decoded preamble, whether the wireless packet is an intra-BSS packet or is an OBSS packet. For example, the time period between the transmission of an intra-BSS packet and the transmission of an OBSS packet may allow a respective AP (or its associated STAs) to decode the preamble of the wireless packet and obtain the BSS color value carried in the wireless packet to determine whether the wireless packet is an intra-BSS packet or an OBSS packet. In this manner, each of the participating APs and their associated STAs may be able to receive and decode intra-BSS packets in the presence of OBSS interference.

In some examples, the sharing AP may perform polling of a set of un-managed or non-co-managed APs that support coordinated reuse to identify candidates for future spatial reuse opportunities. For example, the sharing AP may transmit one or more spatial reuse poll frames as part of determining one or more spatial reuse criteria and selecting one or more other APs to be shared APs. According to the polling, the sharing AP may receive responses from one or more of the polled APs. In some specific examples, the sharing AP may transmit a coordinated AP TXOP indication (CTI) frame to other APs that indicates time and frequency of resources of the TXOP that can be shared. The sharing AP may select one or more candidate APs upon receiving a coordinated AP TXOP request (CTR) frame from a respective candidate AP that indicates a desire by the respective AP to participate in the TXOP. The poll responses or CTR frames may include a power indication, for example, a receive (RX) power or RSSI measured by the respective AP. In some other examples, the sharing AP may directly measure potential interference of a service supported (such as UL transmission) at one or more APs, and select the shared APs based on the measured potential interference. The sharing AP generally selects the APs to participate in coordinated spatial reuse such that it still protects its own transmissions (which may be referred to as primary transmissions) to and from the STAs in its BSS. The selected APs may be allocated resources during the TXOP as described above.

Retransmission protocols, such as hybrid automatic repeat request (HARQ), also may offer performance gains. A HARQ protocol may support various HARQ signaling between transmitting and receiving wireless communication devices (such as the AP 102 and the STAs 104 described with reference to FIG. 1) as well as signaling between the PHY and MAC layers to improve the retransmission operations in a wireless communication network. HARQ uses a combination of error detection and error correction. For example, a HARQ transmission may include error checking bits that are added to data to be transmitted using an error-detecting (ED) code, such as a cyclic redundancy check (CRC). The error checking bits may be used by the receiving device to determine if it has properly decoded the received HARQ transmission. In some examples, the original data (information bits) to be transmitted may be encoded with a forward error correction (FEC) code, such as using a low-density parity check (LDPC) coding scheme that systematically encodes the information bits to produce parity bits. The transmitting device may transmit both the original information bits as well as the parity bits in the HARQ transmission to the receiving device. The receiving device may be able to use the parity bits to correct errors in the information bits, thus avoiding a retransmission.

Implementing a HARQ protocol in a wireless communication network may improve reliability of data communicated from a transmitting device to a receiving device. The HARQ protocol may support the establishment of a HARQ session between the two devices. Once a HARQ session is established, if a receiving device cannot properly decode (and cannot correct the errors) a first HARQ transmission received from the transmitting device, the receiving device may transmit a HARQ feedback message to the transmitting device (such as a negative acknowledgment (NACK)) that indicates at least part of the first HARQ transmission was not properly decoded. Such a HARQ feedback message may be different than the traditional Block ACK feedback message type associated with conventional ARQ. In response to receiving the HARQ feedback message, the transmitting device may transmit a second HARQ transmission to the receiving device to communicate at least part of further assist the receiving device in decoding the first HARQ transmission. For example, the transmitting device may include some or all of the original information bits, some or all of the original parity bits, as well as other, different parity bits in the second HARQ transmission. The combined HARQ transmissions may be processed for decoding and error correction such that the complete signal associated with the HARQ transmissions can be obtained.

In some examples, the receiving device may be enabled to control whether to continue the HARQ process or revert to a non-HARQ retransmission scheme (such as an automatic repeat request (ARQ) protocol). Such switching may reduce feedback overhead and increase the flexibility for retransmissions by allowing devices to dynamically switch between ARQ and HARQ protocols during frame exchanges. Some implementations also may allow multiplexing of communications that employ ARQ with those that employ HARQ.

Some APs and STAs, such as, for example, the AP 102 and STAs 104 described with reference to FIG. 1, are capable of multi-link operation (MLO). For example, the AP 102 and STAs 104 may support MLO as defined in one or both of the IEEE 802.11be and 802.11bn standard amendments. An MLO-capable device may be referred to as a MLD. In some examples, MLO supports establishing multiple different communication links (such as a first link on the 2.4 GHz band, a second link on the 5 GHz band, and the third link on the 6 GHz band) between MLDs. Each communication link may support one or more sets of channels or logical entities. For example, an AP MLD may set, for each of the communication links, a respective operating bandwidth, one or more respective primary channels, and various BSS configuration parameters. An MLD may include a single upper MAC entity, and can include, for example, three independent lower MAC entities and three associated independent PHY entities for respective links in the 2.4 GHz, 5 GHz, and 6 GHz bands. This architecture may enable a single association process and security context. An AP MLD may include multiple APs 102 each configured to communicate on a respective communication link with a respective one of multiple STAs 104 of a non-AP MLD (also referred to as a “STA MLD”).

To support MLO techniques, an AP MLD and a STA MLD may exchange MLO capability information (such as supported aggregation types or supported frequency bands, among other information). In some examples, the exchange of information may occur via a beacon frame, a probe request frame, a probe response frame, an association request frame, an association response frame, another management frame, a dedicated action frame, or an operating mode indicator (OMI), among other examples. In some examples, an AP MLD may designate a specific channel of one link in one of the bands as an anchor channel on which it transmits beacons and other control or management frames periodically. In such examples, the AP MLD also may transmit shorter beacons (such as ones which may contain less information) on other links for discovery or other purposes.

MLDs may exchange packets on one or more of the communications links dynamically and, in some instances, concurrently. MLDs also may independently contend for access on each of the communication links, which achieves latency reduction by enabling the MLD to transmit its packets on the first communication link that becomes available. For example, “alternating multi-link” may refer to an MLO mode in which an MLD may listen on two or more different high-performance links and associated channels concurrently. In an alternating multi-link mode of operation, an MLD may alternate between use of two links to transmit portions of its traffic. Specifically, an MLD with buffered traffic may use the first link on which it wins contention and obtains a TXOP to transmit the traffic. While such an MLD may in some examples be capable of transmitting or receiving on only one communication link at any given time, having access opportunities via two different links enables the MLD to avoid congestion, reduce latency, and maintain throughput.

Multi-link aggregation (MLA) (which also may be referred to as carrier aggregation (CA)) is another MLO mode in which an MLD may simultaneously transmit or receive traffic to or from another MLD via multiple communication links in parallel such that utilization of available resources may be increased to achieve higher throughput. That is, during at least some duration of time, transmissions or portions of transmissions may occur over two or more communication links in parallel at the same time. In some examples, the parallel communication links may support synchronized transmissions. In some other examples, or during some other durations of time, transmissions over the communication links may be parallel, but not be synchronized or concurrent. Additionally, in some examples or durations of time, two or more of the communication links may be used for communications between MLDs in the same direction (such as all uplink or all downlink), while in some other examples or durations of time, two or more of the communication links may be used for communications in different directions (such as one or more communication links may support uplink communications and one or more communication links may support downlink communications). In such examples, at least one of the MLDs may operate in a full duplex mode.

MLA may be packet-based or flow-based. For packet-based aggregation, frames of a single traffic flow (such as all traffic associated with a given traffic identifier (TID)) may be transmitted concurrently across multiple communication links. For flow-based aggregation, each traffic flow (such as all traffic associated with a given TID) may be transmitted using a single respective one of multiple communication links. As an example, a single STA MLD may access a web browser while streaming a video in parallel. Per the above example, the traffic associated with the web browser access may be communicated over a first communication link while the traffic associated with the video stream may be communicated over a second communication link in parallel (such that at least some of the data may be transmitted on the first channel concurrently with data transmitted on the second channel). In some other examples, MLA may be implemented with a hybrid of flow-based and packet-based aggregation. For example, an MLD may employ flow-based aggregation in situations in which multiple traffic flows are created and may employ packet-based aggregation in other situations. Switching among the MLA techniques or modes may additionally, or alternatively, be associated with other metrics (such as a time of day, traffic load within the network, or battery power for a wireless communication device, among other factors or considerations).

Other MLO techniques may be associated with traffic steering and quality of service (QOS) characterization, which may achieve latency reduction and other QoS enhancements by mapping traffic flows having different latency or other requirements to different links. For example, traffic with low latency requirements may be mapped to communication links operating in the 6 GHz band and more latency-tolerant flows may be mapped to communication links operating in the 2.4 GHz or 5 GHz bands. Such an operation, referred to as TID-to-Link mapping (TTLM), may enable two MLDs to negotiate mapping of certain traffic flows in the DL direction or the UL direction or both directions to one or more set of communication links set up between them. In some examples, an AP MLD may advertise a global TTLM that applies to all associated non-AP MLDs. A communication link that has no TIDs mapped to it in either direction is referred to as a disabled link. An enabled link has at least one TID mapped to it in at least one direction.

In some examples, an MLD may include multiple radios and each communication link associated with the MLD may be associated with a respective radio of the MLD. Each radio may include one or more of its own transmit/receive (Tx/Rx) chains, include or be coupled with one or more of its own physical antennas or shared antennas, and include signal processing components, among other components. An MLD with multiple radios that may be used concurrently for MLO may be referred to as a multi-link multi-radio (MLMR) MLD. Some MLMR MLDs may further be capable of an enhanced MLMR (eMLMR) mode of operation, in which the MLD may be capable of dynamically switching radio resources (such as antennas or RF frontends) between multiple communication links (such as switching from using radio resources for one communication link to using the radio resources for another communication link) to enable higher transmission and reception using higher capacity on a given communication link. In this eMLMR mode of operation, MLDs may be able to move Tx/Rx radio resources from one communication link to another link, thereby increasing the spatial stream capability of the other communication link. For example, if a non-AP MLD includes four or more STAs, the STAs associated with the eMLMR links may “pool” their antennas so that each of the STAs can utilize the antennas of other STAs when transmitting or receiving on one of the eMLMR links.

Other MLDs may have more limited capabilities and not include multiple radios. An MLD with only a single radio that is shared for multiple communication links may be referred to as a multi-link single radio (MLSR) MLD. Control frames may be exchanged between MLDs before initiating data or management frame exchanges between the MLDs in implementations in which at least one of the MLDs is operating as an MLSR MLD. Because an MLD operating in the MLSR mode is limited to a single radio, it cannot use multiple communication links simultaneously and may instead listen to (such as monitor), transmit or receive on only a single communication link at any given time. An MLSR MLD may instead switch between different bands in a TDM manner. In contrast, some MLSR MLDs may further be capable of an enhanced MLSR (eMLSR) mode of operation, in which the MLD can concurrently listen on multiple links for specific types of packets, such as buffer status report poll (BSRP) frames or multi-user (MU) request-to-send (RTS) (MU-RTS) frames. Although an MLD operating in the eMLSR mode can still transmit or receive on only one of the links at any given time, it may be able to dynamically switch between bands, resulting in improvements in both latency and throughput. For example, when the STAs of a non-AP MLD may detect a BSRP frame on their respective communication links, the non-AP MLD may tune all of its antennas to the communication link on which the BSRP frame is detected. By contrast, a non-AP MLD operating in the MLSR mode can only listen to, and transmit or receive on, one communication link at any given time.

An MLD that is capable of simultaneous transmission and reception on multiple communication links may be referred to as a simultaneous transmission and reception (STR) device. In a STR-capable MLD, a radio associated with a communication link can independently transmit or receive frames on that communication link without interfering with, or without being interfered with by, the operation of another radio associated with another communication link of the MLD. For example, an MLD with a suitable filter may simultaneously transmit on a 2.4 GHz band and receive on a 5 GHz band, or vice versa, or simultaneously transmit on the 5 GHz band and receive on the 6 GHz band, or vice versa, and as such, be considered a STR device for the respective paired communication links. Such an STR-capable MLD may generally be an AP MLD or a higher-end STA MLD having a higher performance filter. An MLD that is not capable of simultaneous transmission and reception on multiple communication links may be referred to as a non-STR (NSTR) device. A radio associated with a given communication link in an NSTR device may experience interference when there is a transmission on another communication link of the NSTR device. For example, an MLD with a standard filter may not be able to simultaneously transmit on a 5 GHz band and receive on a 6 GHz band, or vice versa, and as such, may be considered a NSTR device for those two communication links.

In some wireless communication systems, an MLD may include multiple non-collocated entities. For example, an AP MLD may include non-collocated AP devices and a STA MLD may include non-collocated STA devices. In examples in which an AP MLD includes multiple non-collocated AP devices, a single mobility domain (SMD) entity may refer to a logical entity that controls the associated non-collocated APs. A non-AP STA (such as a non-MLD non-AP STA or a non-AP MLD that includes one or more associated non-AP STAs) may associate with the SMD entity via one of its constituent APs and may seamlessly roam (such as without requiring reassociation) between the APs associated with the SMD entity. The SMD entity also may maintain other context (such as security and Block ACK) for non-AP STAs associated with it.

The afore-mentioned and related MLO techniques may provide multiple benefits to a wireless communication network 100. For example, MLO may improve user perceived throughput (UPT) (such as by quickly flushing per-user transmit queues). Similarly, MLO may improve throughput by improving utilization of available channels and may increase spectral utilization (such as increasing the bandwidth-time product). Further, MLO may enable smooth transitions between multi-band radios (such as where each radio may be associated with a given RF band) or enable a framework to set up separation of control channels and data channels. Other benefits of MLO include reducing the “on” time of a modem, which may benefit a wireless communication device in terms of power consumption. Another benefit of MLO is the increased multiplexing opportunities in the implementation(s) of a single BSS. For example, MLA may increase the quantity of users per multiplexed transmission served by the multi-link AP MLD.

In some environments, locations, or conditions, a regulatory body may impose a power spectral density (PSD) limit for one or more communication channels or for an entire band (such as the 6 GHz band). A PSD is a measure of transmit power as a function of a unit bandwidth (such as per 1 MHz). The total transmit power of a transmission is consequently the product of the PSD and the total bandwidth by which the transmission is sent. Unlike the 2.4 GHz and 5 GHz bands, the United States Federal Communications Commission (FCC) has established PSD limits for low power devices when operating in the 6 GHz band. The FCC has defined three power classes for operation in the 6 GHz band: standard power, low power indoor, and very low power. Some APs 102 and STAs 104 that operate in the 6 GHz band may conform to the low power indoor (LPI) power class, which limits the transmit power of APs 102 and STAs 104 to 5 decibel-milliwatts per megahertz (dBm/MHz) and −1 dBm/MHz, respectively. In other words, transmit power in the 6 GHz band is PSD-limited on a per-MHz basis.

Such PSD limits can undesirably reduce transmission ranges, reduce packet detection capabilities, and reduce channel estimation capabilities of APs 102 and STAs 104. In some examples in which transmissions are subject to a PSD limit, the AP 102 or the STAs 104 of a wireless communication network 100 may transmit over a greater transmission bandwidth to allow for an increase in the total transmit power, which may increase an SNR and extend coverage of the wireless communication devices. For example, to overcome or extend the PSD limit and improve SNR for low power devices operating in PSD-limited bands, 802.11be introduced a duplicate (DUP) mode for a transmission, by which data in a payload portion of a PPDU is modulated for transmission over a “base” frequency sub-band, such as a first RU of an OFDMA transmission, and copied over (such as duplicated) to another frequency sub-band, such as a second RU of the OFDMA transmission. In DUP mode, two copies of the data are to be transmitted, and, for each of the duplicate RUs, using dual carrier modulation (DCM), which also has the effect of copying the data such that two copies of the data are carried by each of the duplicate RUs, so that, for example, four copies of the data are transmitted. While the data rate for transmission of each copy of the user data using the DUP mode may be the same as a data rate for a transmission using a “normal” mode, the transmit power for the transmission using the DUP mode may be essentially multiplied by the number of copies of the data being transmitted, at the expense of requiring an increased bandwidth. As such, using the DUP mode may extend range but reduce spectrum efficiency.

In some other examples in which transmissions are subject to a PSD limit, a distributed tone mapping operation may be used to increase the bandwidth via which a STA 104 transmits an uplink communication to the AP 102. As used herein, the term “distributed transmission” refers to a PPDU transmission on noncontiguous tones (or subcarriers) of a wireless channel. In contrast, the term “contiguous transmission” refers to a PPDU transmission on contiguous tones. As used herein, a logical RU represents a number of tones or subcarriers that are allocated to a given STA 104 for transmission of a PPDU. As used herein, the term “regular RU” (or rRU) refers to any RU or MRU tone plan that is not distributed, such as a configuration supported by 802.11be or earlier versions of the IEEE 802.11 family of wireless communication protocol standards. As used herein, the term “distributed RU” (or dRU) refers to the tones distributed across a set of noncontiguous subcarrier indices to which a logical RU is mapped. The term “distributed tone plan” refers to the set of noncontiguous subcarrier indices associated with a dRU. The channel or portion of a channel within which the distributed tones are interspersed is referred to as a spreading bandwidth, which may be, for example, 40 MHz, 80 MHz or more. The use of dRUs may be limited to uplink communications because benefits to addressing PSD limits may only be present for uplink communications.

In some examples, a wireless device (such as an AP 102 or a STA 104) may utilize the PHY preamble 302, MAC header 314, or other information (such as a portion) of the PPDU 300 to determine that the PPDU 300 originated from an OBSS. For instance, the wireless device may utilize the BSS color or a MAC address from the MAC header 314 to receive a portion of (such as detect) the PPDU 300, to generate an indication of the PPDU 300, or to transmit an indication of the PPDU 300 to another wireless device, which may be utilized to perform NPCA.

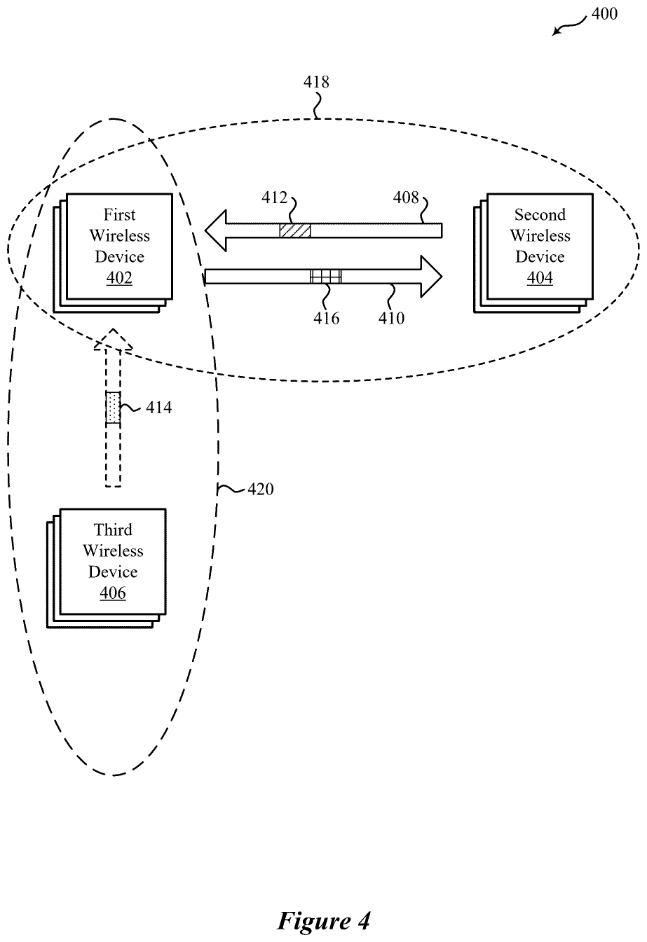

FIG. 4 is a block diagram illustrating examples of wireless devices in a wireless communication system 400 that supports indications for NPCA. The wireless communication system 400 may include one or more first wireless devices 402, one or more second wireless devices 404, or one or more third wireless devices 406. A reference to a first wireless device 402 may refer to one or more first wireless devices 402, a reference to a second wireless device 404 may refer to one or more second wireless devices 404, or reference to a third wireless device 406 may refer to one or more third wireless devices 406. The first wireless device 402 may be an example of the AP 102, the STA 104 (such as a non-AP STA), an AP MLD, a non-AP MLD, or another wireless device. The second wireless device 404 may be an example of the AP 102, the STA 104 (such as a non-AP STA), an AP MLD, a non-AP MLD, or another wireless device. The third wireless device 406 may be an example of the AP 102, the STA 104 (such as a non-AP STA), an AP MLD, a non-AP MLD, or another wireless device.

In some implementations, the second wireless device 404 and the first wireless device 402 may communicate via a first directional communication link 410 from the first wireless device 402 to the second wireless device 404 or a second directional communication link 408 from the second wireless device 404 to the first wireless device 402. In some examples, the first directional communication link 410 may be referred to as an uplink communication link and the second directional communication link 408 may be referred to as a downlink communication link. The first directional communication link 410 or the second directional communication link 408 may be examples of a communication link 106 as illustrated by and described with reference to FIG. 1.

In some examples, the first wireless device 402 or the second wireless device 404 may be included in a BSS 418. The third wireless device 406 may be included in an OBSS 420. The OBSS 420 may differ from the BSS 418. For instance, the OBSS 420 may include one or more wireless devices different from the BSS 418 (such as an AP in the OBSS 420 that is different from an AP of the BSS). The OBSS 420 may overlap with the BSS 418. For instance, a coverage area of the OBSS 420 may overlap with a coverage area of the BSS 418, or signaling in the OBSS 420 may be detectable by one or more wireless devices of the BSS 418. While one OBSS 420 is illustrated in FIG. 4, the OBSS 420 may be one or more OBSSs.

In some examples, the first wireless device 402 may be capable of NPCA or the second wireless device 404 may be capable of NPCA. For instance, the first wireless device 402 or the second wireless device 404 (such as the first wireless device 402 and the second wireless device 404) may be capable of switching from an M-Primary channel to an O-Primary channel when the M-Primary channel is occupied or busy. For example, the first wireless device 402 and the second wireless device 404 may switch to the O-Primary channel when signaling from another wireless device, such as another wireless device in an OBSS, is being transmitted on the M-Primary channel.

In some examples, the second wireless device 404 may transmit, or the first wireless device 402 may receive, a first frame 412 soliciting an indication associated with at least one wireless device in one or more OBSSs (such as OBSS 420) different from the BSS 418. The first wireless device 402 may receive (such as detect) at least a portion of a PPDU 414 communicated by a third wireless device 406. The portion of the PPDU 414 may indicate that the third wireless device 406 is included in the OBSS 420. For instance, the portion of the PPDU 414 may be a PHY header or a MAC header.

In some aspects, the portion of the PPDU 414 may include a BSS color, a MAC address, or other information (as described with reference to FIG. 3, for instance) indicating that the third wireless device 406 is included in the OBSS 420 or is not included in the BSS 418. For example, the BSS color of the PPDU 414 may be different from a BSS color associated with the first wireless device 402, which may enable the first wireless device 402 to determine that the third wireless device 406 is included in the OBSS 420 or in a BSS that is different from the BSS 418.

The first wireless device 402 may transmit, or the second wireless device 404 may receive, a second frame 416 including the indication. The indication may be associated with the portion of the PPDU 414 communicated by the third wireless device 406 in the OBSS 420. For instance, the indication may be transmitted in response to the PPDU 414 or may indicate (such as explicitly or implicitly indicate) that the PPDU 414 was transmitted or is being transmitted on an M-Primary channel.

In some aspects, the first wireless device 402 (such as an NPCA-capable STA) may indicate to the second wireless device 404 (such as a peer NPCA-capable STA) whether the first wireless device 402 may detect one or more PPDUs (such as the PPDU 414) transmitted by one or more other wireless devices (such as the third wireless device 406 (AP or non-AP) in the OBSS 420) in association with the first frame 412 soliciting the indication. For instance, the first wireless device 402 may provide the indication when solicited by the second wireless device 404, such as an NPCA AP may poll a non-AP STA to query if the non-AP STA can detect PPDUs by one or more OBSS STAs.

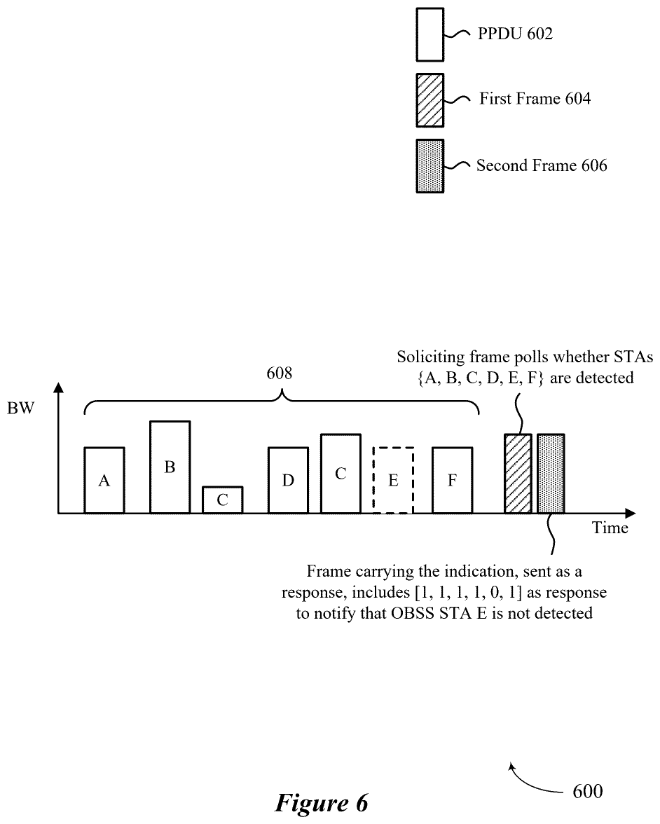

Various examples of approaches where the indication is solicited are provided as follows. In some examples, the solicitation for the indication may be associated with one or more specific wireless devices in the OBSS 420 (such as a specific STA(s) in the OBSS 420) or associated with one or more specific OBSS transmission. The second wireless device 404 (such as a soliciting STA) may indicate one or more identities of the wireless device(s) or PPDU(s) associated with the OBSS 420 for which information is solicited from the first wireless device 402 (such as a solicited STA). In some approaches, the first frame 412 soliciting the indication may include one or more identifiers. One or more identifiers may be associated with the third wireless device 406 or the PPDU 414. The indication of the second frame 416 may be associated with at least one of the one or more identifiers. For example, the second wireless device 404 may include a MAC address of the third wireless device 406 in the OBSS 420 in the first frame 412 (such as a soliciting frame). The first wireless device (such as a responding STA) may indicate whether a PPDU was detected with a transmitter address matching the MAC address. An example of a solicited indication associated with identifiers is provided with reference to FIG. 6.

In some aspects, the first frame 412 (such as a soliciting frame) may solicit information regarding multiple wireless devices in one or more OBSSs (such as OBSS STAs). For example, the first wireless device 402 may receive multiple PPDUs (such as PPDU 414) associated with respective third wireless devices 406. The indication may identify each of the respective third wireless devices 406. For instance, an AP may include an identifier associated with multiple OBSS STAs in the same frame. In some approaches, the first frame 412 may be a trigger frame carrying a user info field, where each user info field corresponds to a specific third wireless device 406 in the OBSS 420 (such as a specific STA).

In some examples, the first frame 412 (such as a request) may solicit information of one or more (such as each or every) third wireless device 406 of the OBSS 420 detected by first wireless device 402 (such as a solicited STA). For instance, if the first wireless device 402 has detected PPDUs from ten neighboring third wireless devices 406 of the OBSS 420, then the second frame 416 or the indication may include corresponding to all ten third wireless devices 406. In some aspects, the first wireless device 402 may include an identity of each third wireless device 406 that is reported. In an example, the second wireless device 404 (such as a non-AP STA) may transmit the first frame 412 (such as a request frame or a probe request) to the first wireless device 402 (such as an AP) requesting information of all the third wireless devices 406 (such as STAs) that the first wireless device 402 detects. In the second frame 416 (such as in a probe response), the first wireless device 402 may include the MAC addresses of all of the third wireless devices 406 detected.

Some identifiers may consume a relatively large quantity of overhead. For example, one or more MAC addresses identifying one or more third wireless devices 406 of the OBSS 420 (as identifiers of the STA(s) that are solicited or provided) may consume a relatively large amount of overhead resources in a frame (such as the first frame 412 soliciting the indication or the second frame 416 carrying the indication). Overhead resource consumption may be increased when information identifying an increased quantity of wireless devices (such as OBSS STA(s)) is solicited or provided.

In some approaches, the first wireless device 402 (such as an NPCA-capable non-AP STA) and the second wireless device 404 (such as an NPCA AP) may communicate or exchange a mapping (such as information indicating an association) between an identifier (such as a shortened identifier relative to a MAC address) of a third wireless device 406 (such as an OBSS STA) and the MAC address of the third wireless device 406. The first wireless device 402 or the second wireless device 404 may transmit or receive a mapping between a MAC identifier and a second identifier of the third wireless device 406. The second identifier may be shorter than the MAC identifier. The second identifier of the third wireless device 406 may be included in the first frame 412, the second frame 416, or a combination thereof. For instance, the mapping may indicate a short identifier of “1” associated with a MAC address of “A1:B1:C1:D1:E1:F1” corresponding to one third wireless device 406 and another short identifier “2” corresponding to a MAC address of “A2:B2:C2:D2:E2:F2” corresponding to another third wireless device 406. In some aspects, the short identifier may be unique within a BSS (such as the BSS 418 of an NPCA AP) or may be pair-wise unique (such as each AP and non-AP STA may define a mapping independently).

The communication or exchange of mapping information may be less frequent than the communication of the indication. For example, the second wireless device 404 may provide an initial mapping when the first wireless device 402 first enables the NPCA mode or performs an initial setup (such as association) with the first wireless device 402. Subsequently, the second wireless device 404 or the first wireless device 402 may transmit a frame to include the updated mapping when a new third wireless device 406 (such as an AP or a non-AP STA) is detected by the second wireless device 404 or the first wireless device 402.

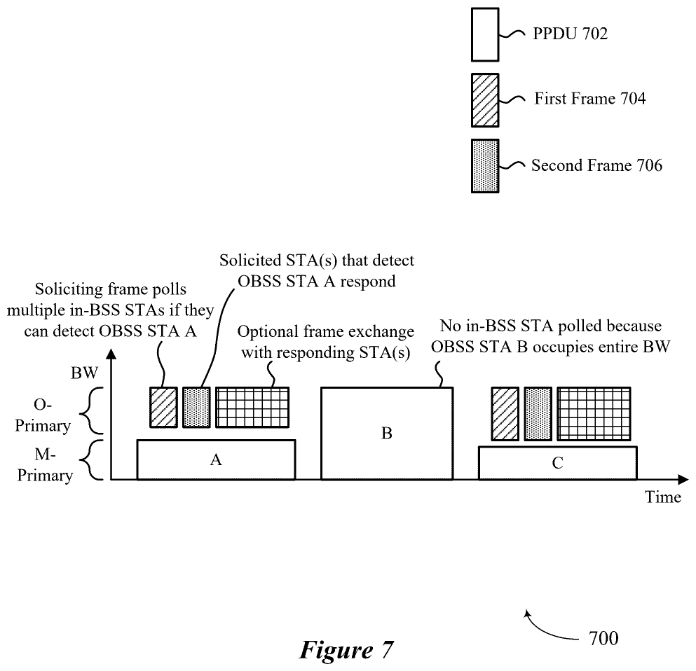

In some aspects, an identity of the wireless device(s) or PPDU(s) associated with the OBSS 420 may be indicated implicitly. For example, the first frame 412 soliciting the indication may be transmitted or received during a communication associated with the PPDU 414 for identification of the third wireless device 406 or the PPDU 414. For instance, an NPCA AP may poll one or more non-AP STAs on the O-Primary channel while the M-Primary channel is busy due to OBSS 420 traffic. Accordingly, the identity of the third wireless device 406 (such as an OBSS 420 STA) may be indicated implicitly. For instance, an AP may poll whether one or more solicited STAs can detect a PPDU currently being transmitted on the M-Primary channel, where the AP has received (such as detected) an identifier of a STA currently transmitting on the M-Primary channel. An example of a solicited indication implicitly associated with an identifier is provided with reference to FIG. 7.

In some approaches, the first frame 412 soliciting the indication may be addressed to a group of wireless devices including the first wireless device 402. For example, the first frame 412 (such as a request) may solicit information from multiple peer STAs concurrently. For instance, an AP may transmit a frame with a broadcast receiver address, such that each STA receiving the frame may respond to the AP. Additionally, or alternatively, the AP may provide a multicast address mapped to specific STAs to respond to the soliciting frame. An example of soliciting an indication from multiple wireless devices is provided with reference to FIG. 7.

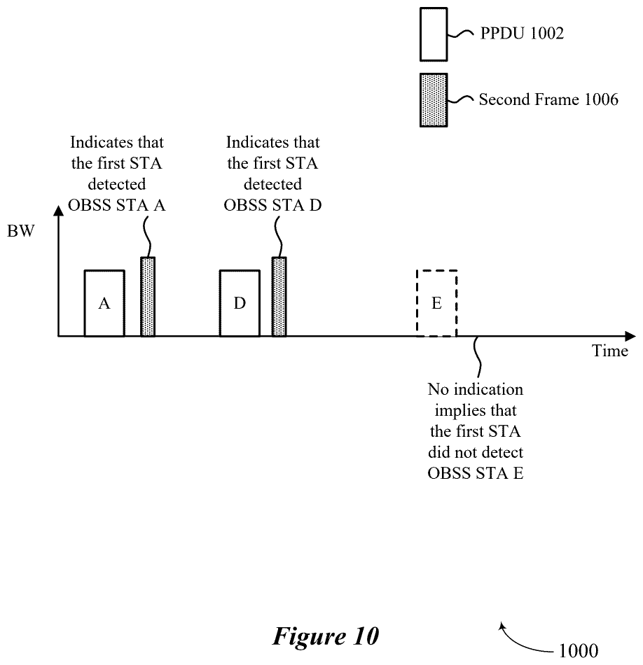

In some examples, the indication may be solicited (via a first frame 412) or may be unsolicited. For instance, the indication of the second frame 416 may be transmitted or received without transmission or reception of a first frame 412 or solicitation. One or more approaches may be utilized for an unsolicited indication. In some approaches, the indication may be associated with a third wireless device 406 of the OBSS 420 (such as associated with a STA or the PPDU 414). An identifier of one or more third wireless device 406 of the OBSS 420 may be included in the second frame 416, which may be an unsolicited frame (such as a frame that is transmitted without an associated soliciting frame). For example, the first wireless device 402 (such as a non-AP STA) may transmit the second frame 416 carrying the indication after (such as within a period after) a third wireless device 406 of the OBSS 420 finishes a transmission on the M-Primary channel. An example of unsolicited indications for respective wireless devices is provided with reference to FIG. 10.

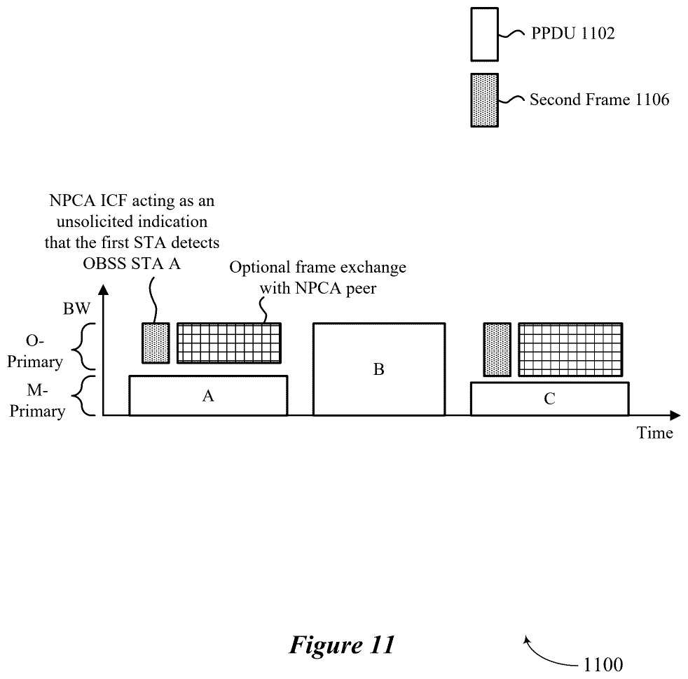

In some approaches, the identity for an unsolicited indication may be indicated implicitly. For example, the second frame 416 including the indication may be transmitted or received during a communication associated with the PPDU 414 for identification of the third wireless device 406 or the PPDU 414. For instance, an NPCA initial control frame (ICF) (such as a request to send (RTS), a multi-user request to send (MU-RTS), a buffer status report poll (BSRP), or a bandwidth query report poll (BQRP)) transmitted by an NPCA STA when the M-Primary channel is busy may serve as an indication that the initiating STA may detect the ongoing OBSS PPDU on the M-Primary channel. Accordingly, the identity of the OBSS STA may be indicated implicitly. An example of implicitly indicating an identifier for an unsolicited indication for respective wireless devices is provided with reference to FIG. 11.

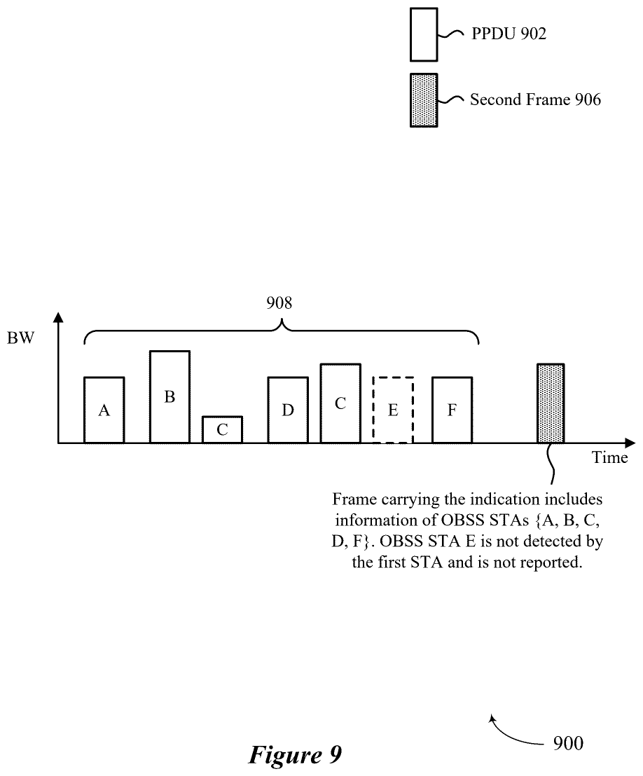

Additionally, or alternatively, the indication may provide information for one or more (such as all) third wireless devices 406 (such as STAs) of the OBSS 420 detected by the first wireless device 402 (such as the indicating STA). An example of providing unsolicited information for respective wireless devices is provided with reference to FIG. 9. In some examples where an AP transmits an indication, a beacon or probe response may be utilized. Some approaches may limit the indication to OBSS APs that are detected (due to a beacon bloat issue). However, providing information for multiple third wireless devices 406 together using more efficient signaling (such as using the short identifier mapping or other approaches described herein), the indication of OBSS non-AP STAs also may be provided.

In some aspects, the first wireless device 402 may transmit, or the second wireless device 404 may receive, the second frame 416 including the indication via a first channel in which the PPDU 414 is received or via a second channel different from the first channel. For instance, the indication may be sent on the M-Primary channel or the O-Primary channel. In some examples, the second wireless device 404 (such as an NPCA AP) may poll one or more first wireless devices 402 (such as STAs) on the O-Primary channel to query whether the polled first wireless device(s) 402 detect an ongoing OBSS PPDU on the M-Primary channel. The first frame 412 (such as a polling frame) also may serve as an NPCA ICF for the polled first wireless device(s) 402. An example of using an O-Primary channel for polling is provided with reference to FIG. 7.

In another example, after the OBSS PPDU 414 transmission has ended on the M-Primary channel, the first wireless device 402 (such as an NPCA non-AP STA) may transmit the second frame 416 as an unsolicited frame (such as a short unsolicited frame) to indicate to the second wireless device 404 (such as an AP) to indicate that the first wireless device 402 detected an OBSS transmission that ended. An example of transmitting an unsolicited frame after an OBSS transmission is provided with reference to FIG. 10.

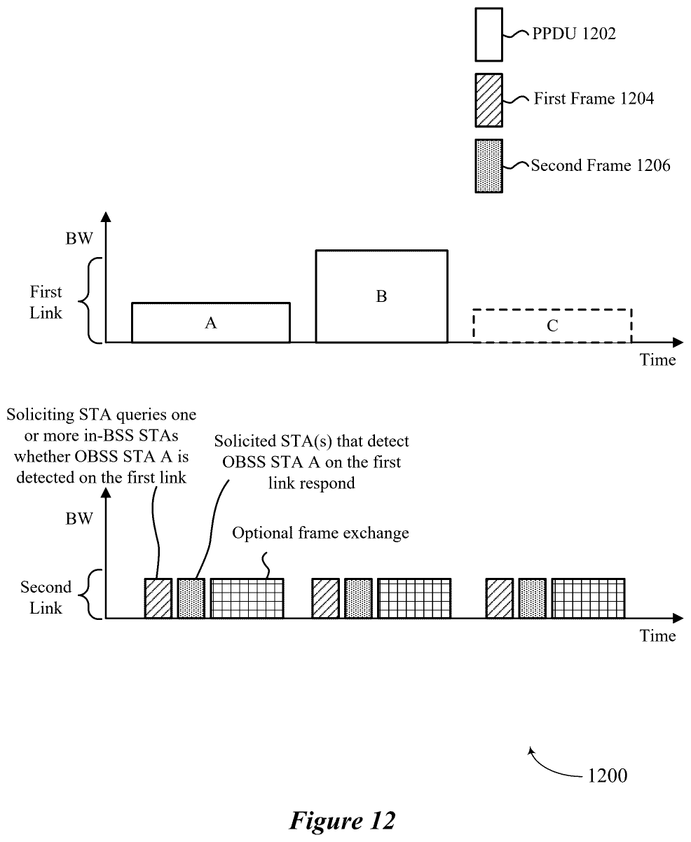

In some aspects, the first wireless device 402 may transmit, or the second wireless device 404 may receive, the second frame 416 including the indication via a second link that is different from a first link via which the PPDU 414 is received, where the first wireless device 402 may be a first MLD and the second wireless device 404 may be a second MLD. For instance, if the second wireless device 404 (such as an NPCA AP) and the first wireless device 402 (such as an NPCA non-AP STA) are affiliated with MLDs, the indication may be transmitted on another link that is set up between the second wireless device 404 and the first wireless device 402. In some examples, first wireless device 402 (such as a transmitting STA) may include an identifier (such as a multi-link link identifier element) for the link for which the information is requested (if the indication is solicited) or provided (if the indication is unsolicited). For instance, an AP may poll a non-AP STAs via a second link (such as a 5 GHz link) regarding whether one or more non-AP STAs detect the OBSS PPDU (such as PPDU 414) currently ongoing on an M-Primary channel of a first link (such as a 2.4 GHz link). An example of transmitting the indication via a second link is provided with reference to FIG. 12.

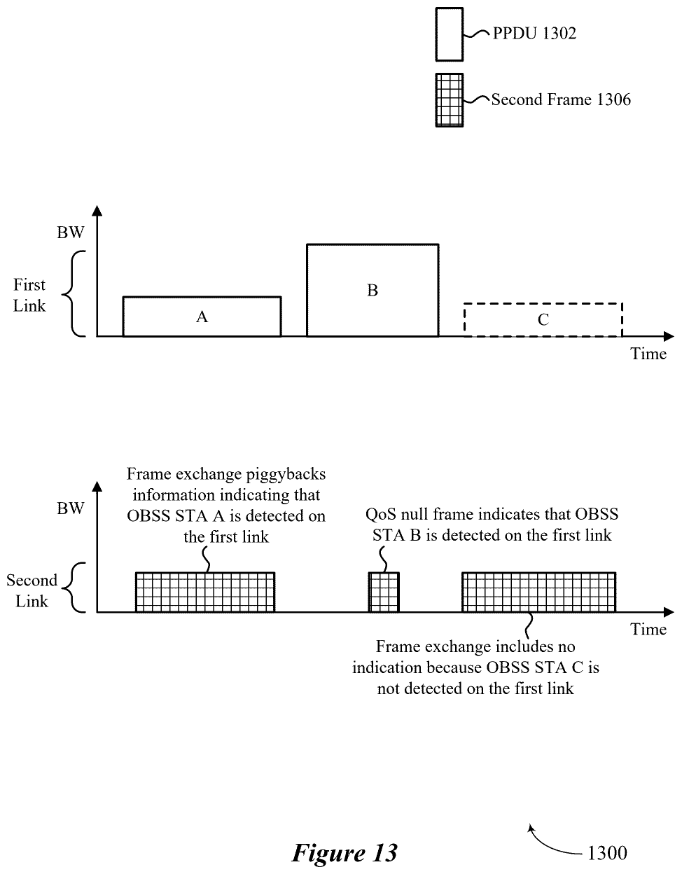

In another example, the first wireless device 402 (such as a non-AP STA) may provide an unsolicited indication on a second link for one or more third wireless devices 406 (such as all the detected OBSS STAs) via the first link. An example of transmitting the unsolicited indication via a second link is provided with reference to FIG. 13. In some examples, the indication may be standalone information (such as quality of service (QOS) null information) or may be combined with other information (such as an A-control frame or an MPDU within an A-MPDU).

In some aspects, the second frame 416 or the indication may be transmitted or received in accordance with various timing approaches. In some approaches, the first wireless device 402 may transmit, or the second wireless device 404 may receive, the second frame 416 including the indication during a communication of the third wireless device 406, where the communication is associated with the PPDU 414. For instance, the indication may be transmitted during the transmission of the third wireless device 406 (such as an OBSS STA). A solicited or unsolicited indication may be transmitted on the O-Primary channel of the same link or an M-Primary channel of another link while the OBSS 420 transmission is ongoing. An example of transmitting the solicited indication via the O-Primary channel is provided with reference to FIG. 7, and an example of transmitting the unsolicited indication via the O-Primary channel is provided with reference to FIG. 11.

In some approaches, the second frame 416 or indication may be transmitted at one or more arbitrary times. For example, the indication may be transmitted when the indication is solicited by the second wireless device (such as a peer NPCA STA). An example of transmitting the solicited indication is provided with reference to FIG. 6. In another example, the second wireless device 404 (such as an NPCA STA) may transmit an unsolicited indication for each time an OBSS PPDU 414 is detected (in a range from the second wireless device). An example of transmitting the unsolicited indication for each PPDU is provided with reference to FIG. 10.

The first wireless device 402 may transmit, or the second wireless device 404 may receive, the second frame 416 after a period including one or more communications including the PPDU 414 communicated by the third wireless device 406. For example, the indication may be transmitted once for a period or quantity of detected PPDUs. An example of transmitting the indication for a period is provided with reference to FIG. 9.

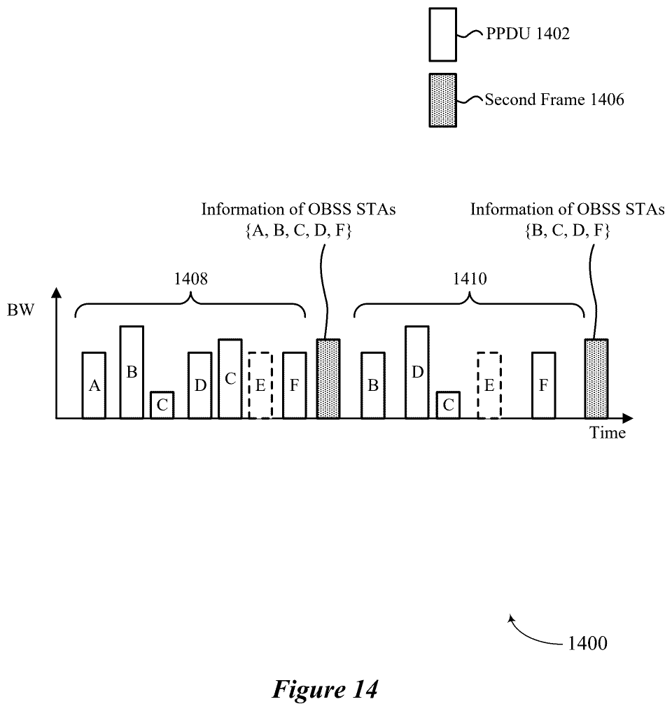

The first wireless device 402 may transmit, or the second wireless device 404 may receive, the second frame 416 for at least one of: a time solicited by the second wireless device 404, each time a new OBSS PPDU is detected by the first wireless device 402 in a range from the first wireless device 402, or a periodic time. In some approaches, the indication may be transmitted at the periodic time (such as repeated periodically). For instance, the periodic time may be a service period (SP) or a target wait time (TWT) SP. For example, during an announced TWT SP, a trigger frame transmitted by the second wireless device 404 (such as an AP) also may poll one or more first wireless devices (such as non-AP STAs) by which OBSS STAs are detected. An example of transmitting the indication periodically is provided with reference to FIG. 14.

In some aspects, the indication may be limited to one or more wireless devices that communicated one or more respective PPDUs within a time window, such as the PPDU 414 communicated by the third wireless device 406. For instance, a time window may be utilized at the first wireless device 402 (such as at the transmitter of the indication). The time window may specify a quantity of time before the current time to check whether a PPDU was received from the third wireless device 406 (such as an OBSS STA). For a time window of 1 second, for instance, the first wireless device 402 that transmits the indication may include information corresponding to a third wireless device 406 if at least a portion of a packet (such as the PPDU 414) was received from that third wireless device 406 in the last 1 second. Utilizing a time window at the first wireless device 402 may ensure that stale information is not indicated.

A time window may be utilized at the second wireless device 404 (such as a receiver of the indication) in some aspects. The time window at the second wireless device 404 may the different from, or the same as, the time window at the first wireless device 402. For instance, the second wireless device 404 may transmit, or the first wireless device 402 may receive, a third frame (not shown in FIG. 4) soliciting another indication in association with a validity of the indication being limited to a time window. The time window may establish a period within which a provided indication remains valid (such as an expiry timer). For example, when the second wireless device 404 (such as a NPCA STA) receives an indication of one or more detected third wireless devices 406 (such as OBSS STAs), the information may be valid for 10 beacon intervals. After the expiration of the time window at the second wireless device 404, the second wireless device 404 may solicit a new indication.

For one or more of the time windows (such as the time window at the first wireless device 402 or the time window at the second wireless device 404), a time window may be established in a specification, indicated in the first frame 412 (such as the solicitation), indicated in the second frame 416 (such as with the indication), or negotiated between the first wireless device 402 and the second wireless device 404 (such as peer STAs). For example, the value of the time window may be included in one or more beacons transmitted by an AP or in a frame transmitted by an NPCA STA when enabling the NPCA mode. For one or more of the time windows, the value of the time window may be different for different third wireless devices 406 (such as different OBSS STAs). For instance, an indicating STA may specify that indication provided for a first OBSS STA is valid for 1024 beacon intervals (due to the first OBSS STA being stationary), while for a second OBSS STA, the indication may be valid for 10 beacon intervals (due to the second OBSS STA being mobile).

In some aspects, the indication may be associated with a type of detected PPDU (such as all PPDU types or non-HT PPDUs). For example, the indication may be limited to a type of PPDU (such as a type of PPDU including the PPDU 414 communicated by the third wireless device 406). For instance, when the first wireless device 402 (such as a transmitting STA) provides the indication, the indication may be specific to a type of PPDU(s) detected by the first wireless device 402. In some examples, the first wireless device 402 may include information of a third wireless device 406 (such as an indication of an OBSS STA) in the indication if the first wireless device 402 has received a non-HT PPDU from that third wireless device 406. In some examples, the first wireless device 402 may include information of a third wireless device 406 in the indication if the first wireless device 402 has received PPDU (regardless of type) from that third wireless device 406.

In some approaches, the first frame 412, the second frame 416, or both may indicate the type of PPDU. For instance, the kind information solicited (corresponding to a non-HT PPDU or any PPDU type) or provided may be indicated in the first frame 412 (such as a soliciting frame) or the second frame 416 (such as a solicited frame) or both.

In some examples, a type of PPDU, including the PPDU 414 communicated by the third wireless device 406, may be associated with a capability of the first wireless device 402, an operation mode of the first wireless device 402, or a combination thereof. For instance, an indication of a type of PPDU may be provided as a capability (such as a capability indicated from the first wireless device 402 to the second wireless device 404). For example, the first wireless device 402 (such as an eMLSR client) may not detect a third wireless device 406 (such as an OBSS STA) when the third wireless device 406 transmits a PPDU that is not a non-HT PPDU. The ability of the first wireless device 402 to receive a type of PPDU, to detect a type of PPDU, or to infer that a PPDU is associated with an OBSS may be indicated as a capability or operating mode by the first wireless device 402 (such as an eMLSR client) to the second wireless device 404 (such as an AP). For example, when the first wireless device 402 enters the eMLSR mode, the first wireless device 402 may not detect PPDUs other than non-HT PPDUs. When the eMLSR mode is disabled, the first wireless device 402 may detect any PPDU type.

In eMLSR, an eMLSR AP may have a primary link (which may be an example of, or similar to, an M-Primary link) and one or more non-primary links (which may be an example of, or similar to, an O-Primary link). In some approaches, when an eMLSR AP or an associated non-AP MLD detects OBSS signaling on the primary link, the AP or STA may switch to the non-primary link and may contend for channel access. The device that wins access to the medium may ensure that the TXOP ends before the end of the OBSS TXOP on the primary channel.

In some examples, a first wireless device 402 that is transitioning from the non-eMLSR mode to the eMLSR mode may indicate to the second wireless device 404 that the first wireless device 402 may be unable (such as temporarily or indefinitely unable) to infer a PPDU as being associated with an OBSS. Additionally, or alternatively, a first wireless device 402 that is transitioning from the eMLSR mode to the non-eMLSR mode may indicate to the second wireless device 404 that the first wireless device 402 may be able to infer a PPDU as being associated with an OBSS. In some approaches, the first wireless device 402 may explicitly indicate to the second wireless device 404 (such as by transmitting a frame) that the first wireless device 402 is unable to infer a PPDU as being associated with an OBSS. Additionally, or alternatively, the first wireless device 402 may explicitly indicate to the second wireless device 404 (such as by transmitting a frame) that the first wireless device 402 may be able to infer a PPDU as being associated with an OBSS.

In some aspects, the indication may be expressed as a binary value or a non-binary value (such as a value within a range of values). For instance, the indication of the second frame 416 may include a binary value or a non-binary value associated with a measurement of a signal indicating the PPDU 414. The binary value or the non-binary value may be indicated in the first frame 412, the second frame 416, or in a combination thereof.

In some approaches, the indication may carry binary information. For example, the first wireless device 402 (such as an STA) transmitting the indication may indicate with binary values a first OBSS STA is detected, that a second OBSS STA is detected, and that a third OBSS STA is not detected. Indications of not detecting a particular third wireless device 406 (such as an OBSS STA) may be applicable when an identity of the third wireless device 406 is solicited or provided. In some examples, the binary information may be associated with a threshold RSSI value. For example, the first frame 412 (such as a soliciting frame) may indicate an RSSI threshold, such that the first wireless device 402 (such as a responding STA) includes the information of a third wireless device 406 (such as an OBSS STA) if that third wireless device 406 or the PPDU 414 is detected at an RSSI greater than the threshold.

In some approaches, the indication may provide granular information (such as information that is more granular than a binary indicator). For example, in addition to an identity (that is explicitly or implicitly indicated) of the third wireless device 406 (such as an OBSS STA), the indication may specify a quantized RSSI value at which the third wireless device 406 or PPDU 414 is detected. The granularity of the information may be specified in the first frame 412 (such as a soliciting frame) or the second frame 416 (such as a solicited frame), or both. Additionally, or alternatively, a fixed granularity may be established in a specification.

The second frame 416 may be transmitted as one or more types of information containers. In some approaches, the second frame 416 may be a management frame, a control frame, or a data frame. For example, the indication may be carried in a management frame (such as an action frame), in a control frame, or in a data frame (such as in an A-control field). Some types of frames may be reused or extended. For instance, the second wireless device 404 (such as an NPCA AP) may solicit an indication from one or more first wireless devices 402 (such as non-AP STAs) on an O-Primary channel regarding whether an ongoing OBSS PPDU 414 is detected on the M-Primary channel. In some approaches, a legacy BSRP and buffer status report (BSR) exchange may be utilized as the first frame 412 (such as a soliciting frame) and the second frame 416 (such as a solicited frame), respectively. In some approaches, an MU-RTS and a clear to send (CTS) exchange may be utilized as the first frame 412 (such as a soliciting frame) and the second frame 416 (such as a solicited frame), respectively. The response frame (or solicited frame, for example) may be sent within a SIFS of receiving the request frame (or soliciting frame, for example).

In some approaches, one or more frames may be modified for use as the first frame 412 or the second frame 416. For instance, a null data packet (NDP) feedback report poll (NFRP) trigger frame may be utilized with a new value for a feedback type subfield (such as value 1) for the first frame 412 (such as a soliciting frame). The response frame (or solicited frame, for example) may be sent within a SIFS of receiving the request frame (or soliciting frame, for example). In some aspects, an NFRP trigger frame or a NFRP-like trigger frame variant may be used as the first frame 412. The first wireless device 402 may transmit, or the second wireless device 404 may receive, the second frame 416 if an AID value of the first wireless device 402 is within an AID range.

In some examples, one or more new action frames may be defined for providing the indication. For instance, a response action frame may be transmitted in a solicited or unsolicited manner. If the indication is solicited, the response frame may not be sent within a SIFS of receiving a request frame. The request frame or the response frame may have an immediate control acknowledgment.

In some examples, one or more new control frames may be defined. For example, a new variant of a trigger frame may be defined as the first frame 412 (such as a soliciting frame). The trigger frame variant may solicit a data frame (such as a QoS null frame) with an A-control field, which may carry the indication of the third wireless device(s) (such as OBSS STAs). The trigger frame variant may be similar to an NFRP frame or may solicit information from a relatively large quantity of first wireless devices 402 (such as solicited STAs).

In some aspects, an AID may be assigned. For example, the first wireless device 402 may be a non-AP STA, the second wireless device 404 may be an AP that assigns an AID value to the first wireless device 402 in association with the first wireless device 402 being capable of NPCA, and the first frame 412 may be a trigger frame indicating a starting AID value and an AID range. The second frame 416 may be transmitted in association with the first wireless device 402 having an AID value within the AID range. When an NFRP or NFRP-like trigger frame is used as the first frame 412 (such as a soliciting frame), for instance, the responding first wireless device(s) 402 may be identified by providing a starting AID value and an AID range. If the AID of a first wireless device 402 (such as an associated STA) is within the range [starting AID, starting AID+AID range], the first wireless device 402 may respond. Otherwise, the first wireless device 402 may not respond. It may be useful for the second wireless device 404 (such as an AP) to assign AIDs to one or more first wireless devices 402 (such as non-AP STAs) that support NPCA within a range. The assignment may ensure that when the second wireless device 404 solicits the indication using an NFRP (or NFRP-like) trigger frame, some (such as all or most) first wireless devices 402 that support NPCA may respond to the soliciting frame. Some approaches may reduce the quantity of frames (such as soliciting and solicited frames) transmitted over the medium or the overhead associated with the indication(s).

In some examples, the second wireless device 404 may communicate, in association with the second frame 416 including the indication, with the first wireless device 402 via a second channel (such as an O-Primary channel) that is different from a first channel (such as an M-Primary channel) in which the PPDU 414 is transmitted. For instance, the first wireless device 402 or the second wireless device 404 may perform one or more aspects of NPCA. For example, if the first wireless device 402 detects the PPDU 414 from the third wireless device 406 in the M-Primary channel and indicates the third wireless device 406 or the PPDU 414 to the second wireless device 404, the second wireless device and the first wireless device 402 may switch to the O-Primary channel for communication while the M-Primary channel is occupied by the third wireless device 406.

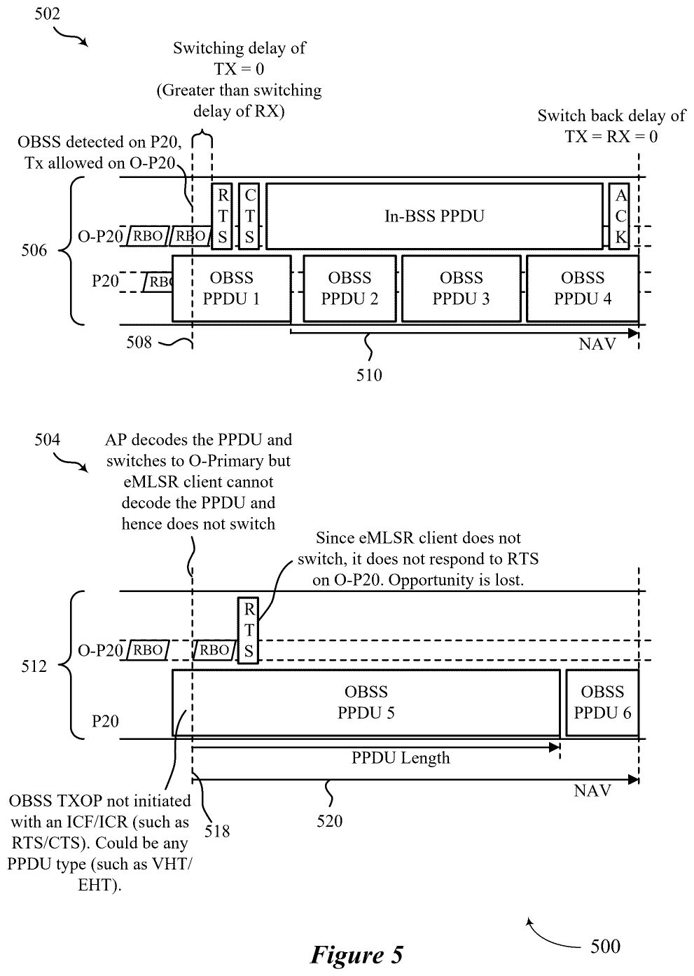

FIG. 5 is a timing diagram illustrating examples of scenarios 500 with successful NPCA and unsuccessful NPCA. Specifically, FIG. 5 illustrates scenarios 500 in which an M-Primary channel with a bandwidth of 20 MHz (denoted “P20”) and an O-Primary channel with a bandwidth of 20 MHz (denoted “O-P20”) are utilized for NPCA over time.

A first scenario 502 provides an example of successful NPCA. In the first scenario, the M-Primary channel and the O-Primary channel are located in a first channel bandwidth 506. Random backoffs (denoted “RBO”) occur on the M-Primary channel and the O-Primary channel. At a first time 508, a first wireless device may be ready to receive (with a switching delay=0). At the first time 508, the first wireless device and a second wireless device detect OBSS PPDU 1, causing the first wireless device and the second wireless device to switch to the O-Primary channel. For example, the second wireless device may transmit an ICF (such as an RTS frame) and the first wireless device may respond with an initial control response (ICR) (such as a CTS frame). After the CTS frame, the second wireless device may transmit one or more PPDUs to the first wireless device in the BSS. Following the PPDU, the first wireless device may transmit an ACK. Activity on the O-Primary channel may continue during a NAV 510 after OBSS PPDU 1. In the first scenario 502, a third wireless device in the OBSS transmits OBSS PPDU 2, OBSS PPDU 3, and OBSS PPDU 4 during the NAV 510.

A second scenario 504 provides an example of unsuccessful NPCA due to a PPDU detection issue for eMLSR clients. In the second scenario 504, the M-Primary channel and the O-Primary channel are located in a second channel bandwidth 512. When an eMLSR client (which may be an example of a wireless device), is performing a listening operation, the eMLSR client may decode (may only decode, for instance) a non-HT PPDU format (or a duplicate non-HT PPDU format). When an OBSS TXOP is initiated with an ICF/ICR exchange on the M-Primary channel, the ICF/ICR is likely to be in the non-HT PPDU format (or duplicate non-HT PPDU format). The eMLSR client may then decode the ICF/ICR frame(s) while in the listening operation and switch to O-Primary channel.

However, if a OBSS TXOP is initiated without any ICF/ICR exchange as shown in the second scenario 504, OBSS PPDU 5 may be in any format. At a second time 518, for example, OBSS PPDU 5 may be in a VHT, HE, EHT, or UHR PPDU format. The eMLSR client may fail to decode the PPDU format and, hence, fails to switch to the O-Primary channel. Because the AP decodes OBSS PPDU 5 and switches to the O-Primary channel, the AP may transmit an RTS frame. Since the eMLSR client fails to switch, the eMLSR client fails to respond to the RTS frame, and the transmission opportunity on the O-Primary channel may be lost. Activity on the O-Primary channel may continue during a NAV 520 after OBSS PPDU 5. In the second scenario 504, a third wireless device in the OBSS transmits OBSS PPDU 6 during the NAV 520. After the NAV 520, the AP may switch back to the M-Primary channel, at which point the eMLSR client may have another opportunity to communicate. As illustrated in the second scenario 504, the switching failure issue may waste resources or opportunities for the transmission of data.

Some of the approaches described herein may help to address the switching failure issue. For instance, the AP may detect OBSS PPDU 5 and may send an indication to the eMLSR client that a third wireless device is transmitting on the M-Primary channel. The eMLSR client may respond by switching to the O-Primary channel, which may enable the eMLSR client to transmit or receive on the O-Primary channel instead of failing to switch as in the second scenario 504.

FIG. 6 is a timing diagram illustrating an example of a solicited indication 600 for NPCA. Specifically, FIG. 6 illustrates a graph in bandwidth (denoted “BW”) over time of an example of a long-term solicited indication of OBSS STAs detected by a first STA. The OBSS STAs may be examples of the third wireless device 406, and the first STA may be an example of the first wireless device 402. The first STA may communicate with a second STA, which may be an example of the second wireless device 404. A first frame 604 and a second frame 606 are also illustrated, where the first frame 604 is an example of the first frame 412 and the second frame 606 is an example of the second frame 416.

In this example, the first STA detects PPDUs 602 corresponding to OBSS STA A, OBSS STA B, OBSS STA C, OBSS STA D, and OBSS STA F, but does not detect a PPDU 602 corresponding to OBSS STA E during a period 608. The second STA may transmit the first frame 604, which may be a soliciting frame that provides identifiers (such as MAC addresses or other identifiers) corresponding to OBSS STA A, OBSS STA B, OBSS STA C, OBSS STA D, OBSS STA E, and OBSS STA F. In this example, the first STA sends the indication corresponding to the identifiers of the solicitation, where the indication includes binary indicators (such as bits), indicating that OBSS STA A, OBSS STA B, OBSS STA C, OBSS STA D, and OBSS STA F are detected, but that OBSS STA E is not detected.

FIG. 7 is a timing diagram illustrating an example of a solicited indication 700 with different channels that supports indications for NPCA. Specifically, FIG. 7 illustrates a graph in bandwidth (denoted “BW”) over time of an example of a short-term solicited indication of OBSS STAs detected by a first STA(s). The OBSS STAs may be examples of the third wireless device 406, and the first STA(s) may be an example of the first wireless device 402. The first STA(s) may communicate with a second STA, which may be an example of the second wireless device 404. A first frame 704 and a second frame 706 are also illustrated, where the first frame 704 is an example of the first frame 412 and the second frame 706 is an example of the second frame 416.

In this example, the second STA sends the first frame 704 to the first STA(s) (such as multiple in-BSS STAs) on the O-Primary channel, where the first frame 704 polls the first STA(s) regarding whether the first STA(s) detect the current PPDU 702 corresponding to OBSS STA A on the M-Primary channel. The first STA(s) that detect OBSS STA A may transmit the second frame 706 to the second STA. A similar procedure may be followed for OBSS STA C. As illustrated in FIG. 7, an optional frame exchange may occur on the O-Primary channel between the first STA(s) and the second STA. During a PPDU 702 corresponding to OBSS STA B, no in-BSS STA may be polled due to OBSS STA B occupying the bandwidth.

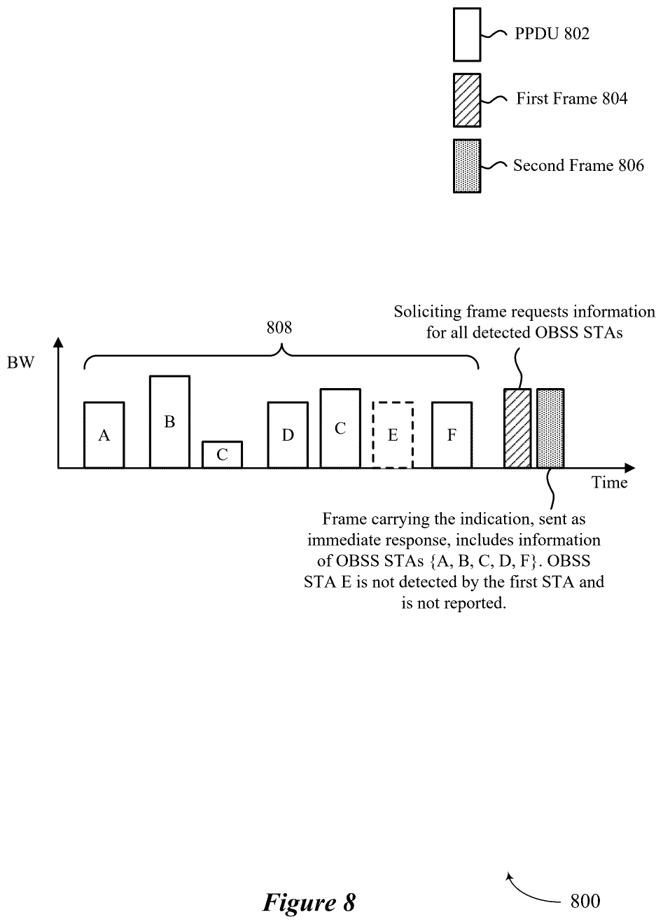

FIG. 8 is a timing diagram illustrating an example of a solicited indication 800, where a frame carrying the indication provides information for OBSS STAs. Specifically, FIG. 8 illustrates a graph in bandwidth (denoted “BW”) over time of an example of a long-term solicited indication of any or all OBSS STAs detected by a first STA. The OBSS STAs may be examples of the third wireless device 406, and the first STA may be an example of the first wireless device 402. The first STA may communicate with a second STA, which may be an example of the second wireless device 404. A first frame 804 and a second frame 806 are also illustrated, where the first frame 804 is an example of the first frame 412 and the second frame 806 is an example of the second frame 416.

In this example, the first STA detects PPDUs 802 corresponding to OBSS STA A, OBSS STA B, OBSS STA C, OBSS STA D, and OBSS STA F, but does not detect a PPDU 802 corresponding to OBSS STA E during a period 808. The second STA may transmit the first frame 804, which may be a soliciting frame requesting information for any or all detected OBSS STAs (without identifiers, for instance). In this example, the first STA sends the indication, where the indication includes identifiers (such as MAC addresses or other identifiers, for instance), indicating that OBSS STA A, OBSS STA B, OBSS STA C, OBSS STA D, and OBSS STA F are detected. OBSS STA E is not detected and is not reported.

FIG. 9 is a timing diagram illustrating an example of an unsolicited indication 900, where a frame carrying the indication provides information for OBSS STAs. Specifically, FIG. 9 illustrates a graph in bandwidth (denoted “BW”) over time of an example of a long-term unsolicited indication of OBSS STAs detected by a first STA. The OBSS STAs may be examples of the third wireless device 406, and the first STA may be an example of the first wireless device 402. The first STA may communicate with a second STA, which may be an example of the second wireless device 404. A second frame 906 is also illustrated, where the second frame 906 is an example of the second frame 416.

In this example, the first STA detects PPDUs 902 corresponding to OBSS STA A, OBSS STA B, OBSS STA C, OBSS STA D, and OBSS STA F, but does not detect a PPDU 902 corresponding to OBSS STA E during a period 908. In this example, the first STA sends the (unsolicited) indication to the second STA, where the indication includes identifiers (such as MAC addresses or other identifiers, for instance), indicating that OBSS STA A, OBSS STA B, OBSS STA C, OBSS STA D, and OBSS STA F are detected. OBSS STA E is not detected and is not reported.

FIG. 10 is a timing diagram illustrating an example of unsolicited indications 1000 following physical layer (PHY) protocol data units (PPDUs) of detected OBSS STAs. Specifically, FIG. 10 illustrates a graph in bandwidth (denoted “BW”) over time of an example of a short-term unsolicited indication of OBSS STAs detected by a first STA(s). The OBSS STAs may be examples of the third wireless device 406, and the first STA(s) may be an example of the first wireless device 402. The first STA(s) may communicate with a second STA, which may be an example of the second wireless device 404. A second frame 1006 is also illustrated, where the second frame 1006 is an example of the second frame 416.

In this example, the first STA sends an unsolicited indication in a second frame 1006 after a PPDU 1002 corresponding to OBSS STA A is detected. The first STA also sends another unsolicited indication in a second frame 1006 after a PPDU 1002 corresponding to OBSS STA D is detected. However, the first STA does not send an indication after a PPDU 1002 corresponding to OBSS STA E, which may imply that the first STA did not detect the PPDU 1002 corresponding to OBSS STA E.

FIG. 11 is a timing diagram illustrating an example of an unsolicited indication 1100 with different channels that supports indications for NPCA. Specifically, FIG. 11 illustrates a graph in bandwidth (denoted “BW”) over time of an example of a short-term unsolicited indication of OBSS STAs detected by a first STA(s). The OBSS STAs may be examples of the third wireless device 406, and the first STA(s) may be an example of the first wireless device 402. The first STA(s) may communicate with a second STA, which may be an example of the second wireless device 404. A second frame 1106 is also illustrated, where the second frame 1106 is an example of the second frame 416.

In this example, the first STA sends the second frame 1106 to the second STA on the O-Primary channel. The second frame 1106 may be an NPCA ICF acting as an unsolicited indication that the first STA detects OBSS STA A on the M-Primary channel. A similar procedure may be followed for OBSS STA C. As illustrated in FIG. 11, an optional frame exchange may occur on the O-Primary channel between the first STA(s) and the second STA. During a PPDU 1102 corresponding to OBSS STA B, no in-BSS STA may be polled due to OBSS STA B occupying the bandwidth.

FIG. 12 is a timing diagram illustrating an example of a solicited indication 1200 with different links that supports indications for NPCA. Specifically, FIG. 12 illustrates graphs in bandwidths (denoted “BW”) over time of an example of a cross-link short-term solicited indication of OBSS STAs detected by a first STA(s). The OBSS STAs may be examples of the third wireless device 406, and the first STA(s) may be an example of the first wireless device 402. The first STA(s) may communicate with a second STA, which may be an example of the second wireless device 404. A first frame 1204 and a second frame 1206 are also illustrated, where the first frame 1204 is an example of the first frame 412 and the second frame 1206 is an example of the second frame 416.

In this example, the second STA sends the first frame 1204 to the first STA(s) (such as multiple in-BSS STAs) on the second link, where the first frame 1204 polls the first STA(s) regarding whether the first STA(s) detect the current PPDU 1202 corresponding to OBSS STA A on the first link (such as on the M-Primary channel on the first link). The first STA(s) that detect OBSS STA A may transmit the second frame 1206 to the second STA on the second link. A similar procedure may be followed for OBSS STA B or OBSS STA C. As illustrated in FIG. 12, an optional frame exchange may occur on the second link.

FIG. 13 is a timing diagram illustrating an examples of unsolicited

indications 1300 via frame exchanges and a null frame with different links that supports indications for NPCA. Specifically, FIG. 13 illustrates graphs in bandwidths (denoted “BW”) over time of an example of a cross-link short-term unsolicited indication of OBSS STAs detected by a first STA(s). The OBSS STAs may be examples of the third wireless device 406, and the first STA(s) may be an example of the first wireless device 402. The first STA(s) may communicate with a second STA, which may be an example of the second wireless device 404. A second frame 1306 is also illustrated, where the second frame 1306 is an example of the second frame 416.

In this example, the first STA(s) that detect OBSS STA A on the first link may transmit the second frame 1306 to the second STA on the second link, where the second frame 1306 may be transmitted as part of a frame exchange. The first STA(s) that detect a PPDU 1302 of the OBSS STA B on the first link may transmit the second frame 1306 to the second STA on the second link, where the second frame 1306 may be transmitted as a QoS null frame. Because the first STA(s) do not detect OBSS STA C on the first link, a frame exchange may not include an indication of OBSS STA C.

FIG. 14 is a timing diagram illustrating an examples of periodic unsolicited indications 1400. Specifically, FIG. 14 illustrates a graph in bandwidth (denoted “BW”) over time of an example of a long-term unsolicited indications of OBSS STAs detected by a first STA. The OBSS STAs may be examples of the third wireless device 406, and the first STA may be an example of the first wireless device 402. The first STA may communicate with a second STA, which may be an example of the second wireless device 404. A second frame 1406 is also illustrated, where the second frame 1406 is an example of the second frame 416.

In this example, the first STA detects PPDUs 1402 corresponding to OBSS STA A, OBSS STA B, OBSS STA C, OBSS STA D, and OBSS STA F, but does not detect a PPDU 1402 corresponding to OBSS STA E during a first period 1408. In this example, the first STA sends an (unsolicited) indication to the second STA for the first period 1408, where the indication includes identifiers (such as MAC addresses or other identifiers, for instance), indicating that OBSS STA A, OBSS STA B, OBSS STA C, OBSS STA D, and OBSS STA F are detected. OBSS STA E is not detected and is not reported for the first period 1408. The first STA detects PPDUs 1402 corresponding to OBSS STA B, OBSS STA C, OBSS STA D, and OBSS STA F, but does not detect a PPDU 1402 corresponding to OBSS STA E during a second period 1410. In this example, the first STA sends an (unsolicited) indication to the second STA for the second period 1410, where the indication includes identifiers (such as MAC addresses or other identifiers, for instance), indicating that OBSS STA B, OBSS STA C, OBSS STA D, and OBSS STA F are detected. OBSS STA E is not detected and is not reported for the second period 1410.

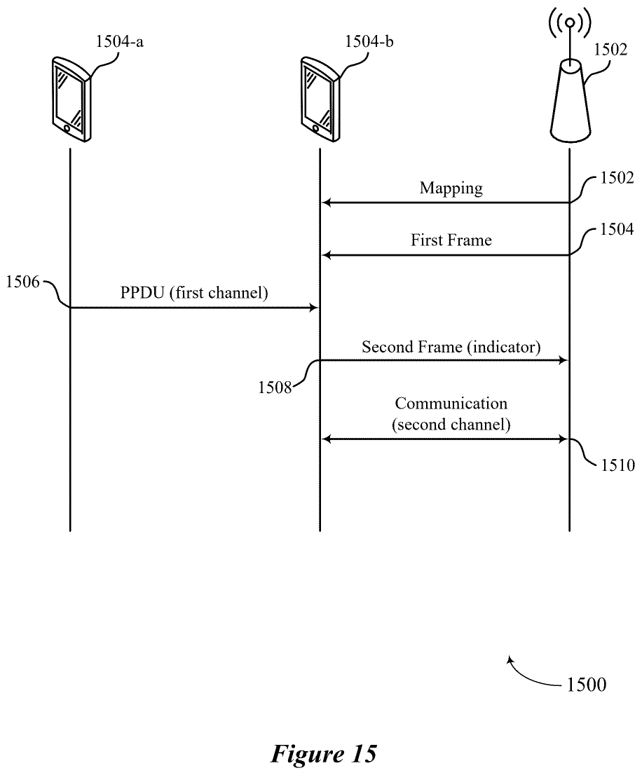

FIG. 15 shows an example of a process flow 1500 that supports indications for NPCA. The process flow 1500 may implement or be implemented to realize or facilitate aspects of the wireless communication network 100 or the wireless communication system 400. For example, the process flow 1500 illustrates a first UE 1504-a, and illustrates communication between a second UE 1504-b and an AP 1502. The first UE 1504-a may be an example of the third wireless device 406 described with reference to FIG. 4. The second UE 1504-b may be an example of the first wireless device 402 described with reference to FIG. 4. The AP 1502 may be an example of the second wireless device 404 described with reference to FIG. 4.

In the following description of the process flow 1500, the operations may be performed (such as reported or provided) in a different order than the order shown, or the operations performed by the example devices may be performed in different orders or at different times. For example, one or more operations also may be omitted from the process flow 1500, or one or more operations may be added to the process flow 1500. Further, although some operations or signaling may be shown to occur at different times for discussion purposes, two or more operations may actually occur concurrently or in overlapping time frames in some examples.

At 1502, the second UE 1504-b or the AP 1502 may communicate a mapping. For instance, the AP 1502 may transmit a mapping between a MAC identifier and a second identifier of the first UE 1504-a to the second UE 1504-b as described with reference to FIG. 4.

At 1504, the AP 1502 may transmit a first frame to the second UE 1504-b. For instance, the AP 1502 may transmit a first frame soliciting an indication from the second UE 1504-b as described with reference to FIG. 4.

At 1506, the first UE 1504-a may transmit a PPDU on a first channel. The second UE 1504-b may receive or detect at least a portion of the PPDU. For instance, the second UE 1504-b may receive and decode a PHY header, MAC header (such as a MAC address), or other information of the PPDU to identify the first UE 1504-a as described with reference to FIG. 4.

At 1508, the second UE 1504-b may transmit a second frame to the AP 1502. For instance, the second UE 1504-b may transmit a second frame including an indicator as described with reference to FIG. 4. The indicator may include the second identifier corresponding to the first UE 1504-a. For instance, the second UE 1504-b may utilize the mapping to select the second identifier corresponding to the MAC address of the first UE 1504-a and may include the second identifier in the second frame.

At 1510, the AP 1502 and the second UE 1504-b may communicate on a second channel. For instance, the AP 1502 and the second UE 1504-b may communicate an O-Primary channel as described with reference to FIG. 4.

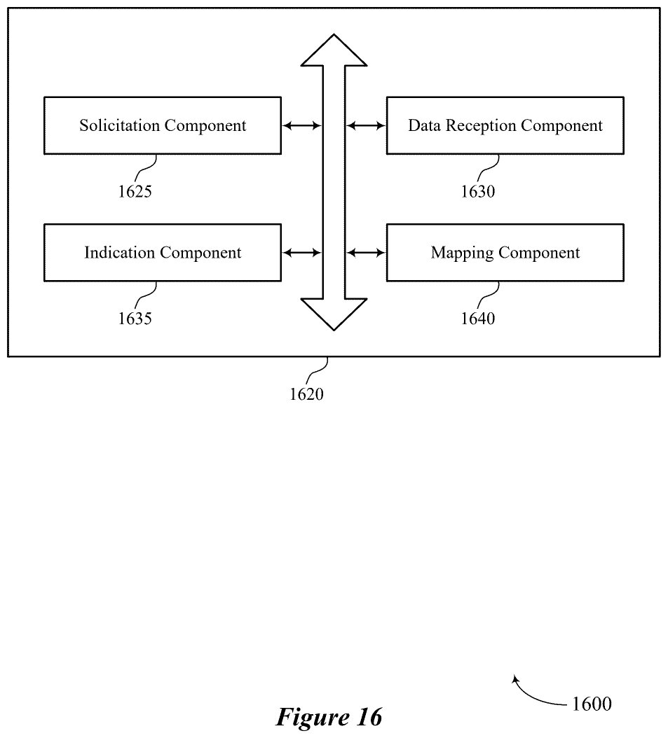

FIG. 16 is a block diagram 1600 illustrating an example of a first wireless device 1620 that supports indications for NPCA. The first wireless device 1620 may be an example of aspects of a first wireless device, an AP, or a STA as described with reference to FIGS. 1 through 15. The first wireless device 1620, or various components thereof, may be an example of means for performing various aspects of indications for NPCA as described herein. For example, the first wireless device 1620 may include a solicitation component 1625, a data reception component 1630, an indication component 1635, a mapping component 1640, or any combination thereof. Each of these components, or components or subcomponents thereof (such as one or more processors, one or more memories), may communicate, directly or indirectly, with one another (such as via one or more buses).

The first wireless device 1620 may support wireless communication in accordance with examples as disclosed herein. The solicitation component 1625 is configurable or configured to receive, from a second wireless device capable of NPCA (NPCA), a first frame soliciting an indication associated with at least one wireless device in an OBSS different from a BSS that includes at least one of the first wireless device and the second wireless device, the first wireless device being capable of NPCA. The data reception component 1630 is configurable or configured to receive a portion of a PPDU communicated by a third wireless device, the portion of the PPDU indicating that the third wireless device is included in the OBSS. The indication component 1635 is configurable or configured to transmit, to the second wireless device, a second frame including the indication, the indication being associated with the portion of the PPDU.

In some examples, to support transmitting the second frame including the indication, the indication component 1635 is configurable or configured to transmit the second frame including the indication via a first channel in which the PPDU is received or via a second channel different from the first channel.

In some examples, to support transmitting the second frame including the indication, the indication component 1635 is configurable or configured to transmit the second frame including the indication via a second link that is different from a first link via which the PPDU is received, the first wireless device being a first MLD and the second wireless device being a second MLD.

In some examples, to support transmitting the second frame including the indication, the indication component 1635 is configurable or configured to transmit the second frame including the indication during a communication of the third wireless device, the communication being associated with the PPDU.

In some examples, to support transmitting the second frame, the indication component 1635 is configurable or configured to transmit the second frame for at least one of: a time solicited by the second wireless device, each time a new OBSS PPDU is detected by the first wireless device in a range from the first wireless device, or a periodic time.

In some examples, the indication is limited to one or more wireless devices that communicated one or more respective PPDUs within a time window, including the PPDU communicated by the third wireless device.

In some examples, the indication is limited to a type of PPDU, the type of PPDU including the PPDU communicated by the third wireless device.

In some examples, the first frame, the second frame, or a combination thereof indicates the type of PPDU.

In some examples, a type of PPDU, including the PPDU communicated by the third wireless device, is associated with a capability of the first wireless device, an operation mode of the first wireless device, or a combination thereof.

In some examples, the indication includes a binary value or a non-binary value associated with a measurement of a signal indicating the PPDU, the binary value or the non-binary value being indicated in the first frame, the second frame, or a combination thereof.

In some examples, the second frame is a management frame, a control frame, or a data frame. In some aspects, an NFRP trigger frame or a NFRP-like trigger frame variant may be used as the first frame. The first wireless device may transmit, or the second wireless device may receive, the second frame if an AID value of the first wireless device is within an AID range.

In some examples, the mapping component 1640 is configurable or configured to communicate, with the second wireless device, a mapping between a MAC identifier and a second identifier of the third wireless device, the second identifier being shorter than the MAC identifier, the second identifier of the third wireless device being included in the first frame, the second frame, or a combination thereof.

In some examples, the first wireless device is a non-AP STA, the second wireless device is an AP that assigns an AID value to the first wireless device in association with the first wireless device being capable of NPCA, and the first frame is a trigger frame indicating a starting AID value and an AID range, the second frame being transmitted in association with the first wireless device having an AID value within the AID range.

In some examples, the first frame soliciting the indication includes one or more identifiers, at least one of the one or more identifiers being associated with the third wireless device or the PPDU, and the indication being associated with at least one of the one or more identifiers.

In some examples, the first frame soliciting the indication is received during a communication associated with the PPDU for identification of the third wireless device or the PPDU.

In some examples, the first frame soliciting the indication is addressed to a group of wireless devices including the first wireless device.

In some examples, to support receiving the portion of the PPDU, the data reception component 1630 is configurable or configured to receive multiple PPDUs associated with respective third wireless devices, the indication identifying each of the respective third wireless devices.

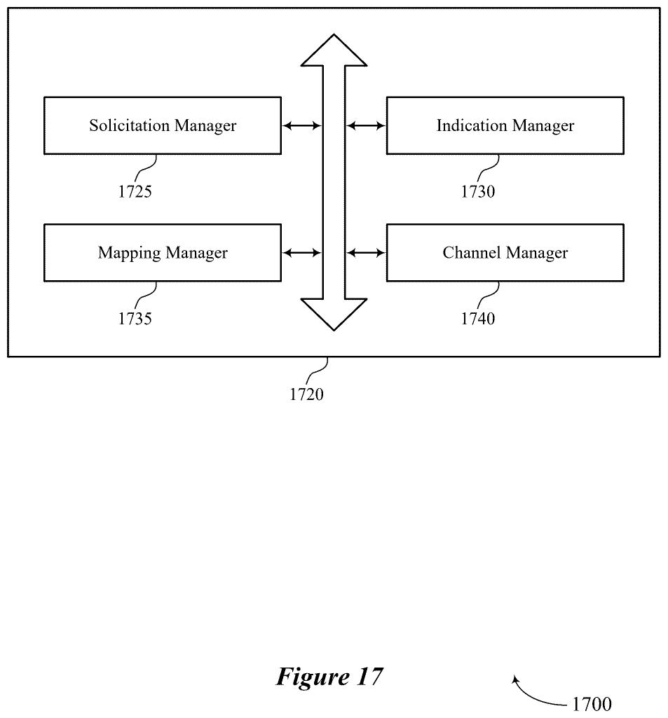

FIG. 17 is a block diagram 1700 illustrating an example of a second wireless device 1720 that supports indications for NPCA. The second wireless device 1720 may be an example of aspects of a second wireless device, an AP, or a STA as described with reference to FIGS. 1 through 15. The second wireless device 1720, or various components thereof, may be an example of means for performing various aspects of indications for NPCA as described herein. For example, the second wireless device 1720 may include a solicitation manager 1725, an indication manager 1730, a mapping manager 1735, a channel manager 1740, or any combination thereof. Each of these components, or components or subcomponents thereof (such as one or more processors, one or more memories), may communicate, directly or indirectly, with one another (such as via one or more buses).

The second wireless device 1720 may support wireless communication in accordance with examples as disclosed herein. The solicitation manager 1725 is configurable or configured to transmit, to a first wireless device capable of NPCA, a first frame soliciting an indication associated with at least one wireless device in an OBSS different from a BSS that includes at least one of the first wireless device and the second wireless device, the second wireless device being capable of NPCA. The indication manager 1730 is configurable or configured to receive, from the first wireless device, a second frame including the indication, the indication being associated with a portion of a PPDU communicated by a third wireless device in the OBSS.

In some examples, to support receiving the second frame including the indication, the indication manager 1730 is configurable or configured to receive the second frame including the indication via a first channel in which the PPDU is transmitted or via a second channel different from the first channel.

In some examples, to support receiving the second frame including the indication, the indication manager 1730 is configurable or configured to receive the second frame including the indication via a second link that is different from a first link via which the PPDU is communicated, the first wireless device being a first MLD and the second wireless device being a second MLD.

In some examples, the indication manager 1730 is configurable or configured to transmit a third frame soliciting another indication in association with a validity of the indication being limited to a time window.

In some examples, the indication is limited to a type of PPDU, the type of PPDU including the PPDU communicated by the third wireless device.

In some examples, a type of PPDU, including the PPDU communicated by the third wireless device, is associated with a capability of the first wireless device, an operation mode of the first wireless device, or a combination thereof.

In some examples, the indication includes a binary value or a non-binary value associated with a measurement of a signal indicating the PPDU, the binary value or the non-binary value being indicated in the first frame, the second frame, or a combination thereof.

In some examples, the mapping manager 1735 is configurable or configured to communicate, with the first wireless device, a mapping between a MAC identifier and a second identifier of the third wireless device, the second identifier being shorter than the MAC identifier, the second identifier of the third wireless device being included in the first frame, the second frame, or a combination thereof.

In some examples, the first wireless device is a non-AP STA, the second wireless device is an AP that assigns an AID value to the first wireless device in association with the first wireless device being capable of NPCA, and the first frame is a trigger frame indicating a starting AID value and an AID range, the second frame being transmitted in association with the first wireless device having an AID value within the AID range.

In some examples, the first frame soliciting the indication is transmitted during a communication associated with the PPDU for identification of the third wireless device or the PPDU.

In some examples, the channel manager 1740 is configurable or configured to communicate, in association with the second frame including the indication, with the first wireless device via a second channel that is different from a first channel in which the PPDU is transmitted.

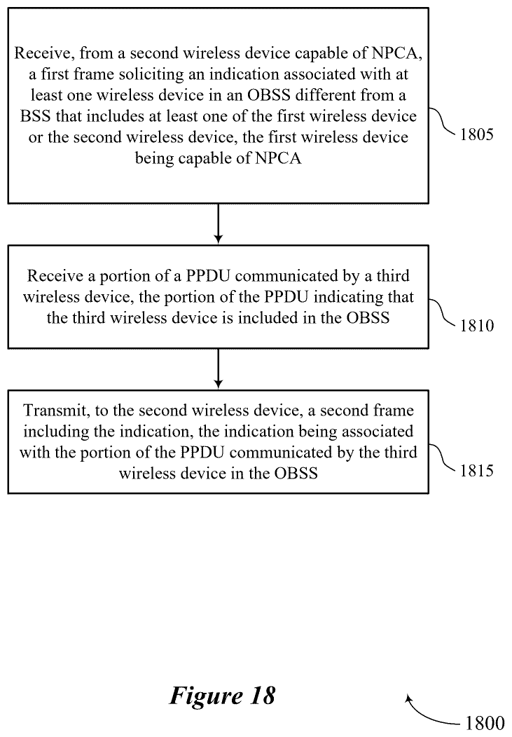

FIG. 18 shows a flowchart illustrating a method 1800 that supports indications for NPCA. The operations of the method 1800 may be implemented by a first wireless device or its components as described herein. For example, the operations of the method 1800 may be performed by a first wireless device as described with reference to FIGS. 1 through 16. In some examples, a first wireless device may execute a set of instructions to control the functional elements of the first wireless device to perform the described functions. Additionally, or alternatively, the first wireless device may perform aspects of the described functions using special-purpose hardware.

At 1805, the method may include receiving, from a second wireless device capable of NPCA, a first frame soliciting an indication associated with at least one wireless device in an OBSS different from a BSS that includes at least one of the first wireless device and the second wireless device, the first wireless device being capable of NPCA. The operations of 1805 may be performed in accordance with examples as disclosed herein. In some examples, aspects of the operations of 1805 may be performed by a solicitation component 1625 as described with reference to FIG. 16.

At 1810, the method may include receiving a portion of a PPDU communicated by a third wireless device, the portion of the PPDU indicating that the third wireless device is included in the OBSS. The operations of 1810 may be performed in accordance with examples as disclosed herein. In some examples, aspects of the operations of 1810 may be performed by a data reception component 1630 as described with reference to FIG. 16.

At 1815, the method may include transmitting, to the second wireless device, a second frame including the indication, the indication being associated with the portion of the PPDU. The operations of 1815 may be performed in accordance with examples as disclosed herein. In some examples, aspects of the operations of 1815 may be performed by an indication component 1635 as described with reference to FIG. 16.

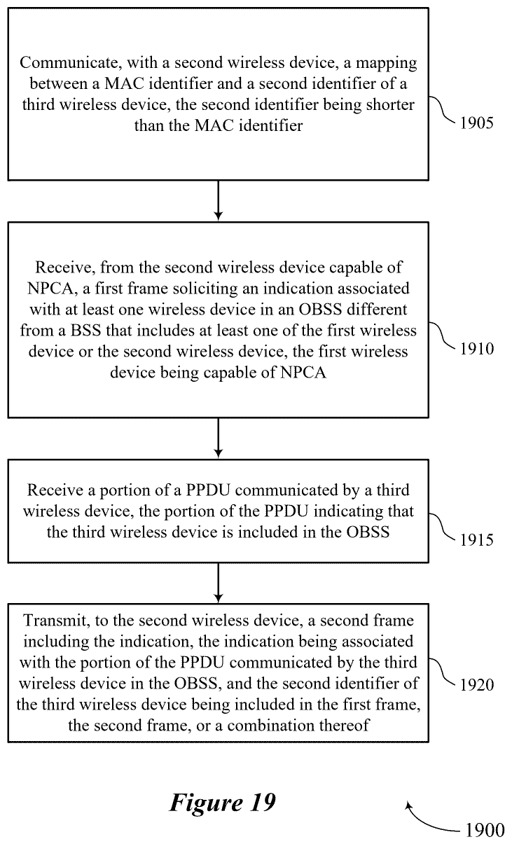

FIG. 19 shows a flowchart illustrating a method 1900 that supports indications for NPCA. The operations of the method 1900 may be implemented by a first wireless device or its components as described herein. For example, the operations of the method 1900 may be performed by a first wireless device as described with reference to FIGS. 1 through 16. In some examples, a first wireless device may execute a set of instructions to control the functional elements of the first wireless device to perform the described functions. Additionally, or alternatively, the first wireless device may perform aspects of the described functions using special-purpose hardware.

At 1905, the method may include communicating, with a second wireless device, a mapping between a MAC identifier and a second identifier of the third wireless device, the second identifier being shorter than the MAC identifier. The operations of 1905 may be performed in accordance with examples as disclosed herein. In some examples, aspects of the operations of 1905 may be performed by a mapping component 1640 as described with reference to FIG. 16.

At 1910, the method may include receiving, from the second wireless device capable of NPCA, a first frame soliciting an indication associated with at least one wireless device in an OBSS different from a BSS that includes at least one of the first wireless device and the second wireless device, the first wireless device being capable of NPCA. The operations of 1910 may be performed in accordance with examples as disclosed herein. In some examples, aspects of the operations of 1910 may be performed by a solicitation component 1625 as described with reference to FIG. 16.

At 1915, the method may include receiving a portion of a PPDU communicated by a third wireless device, the portion of the PPDU indicating that the third wireless device is included in the OBSS, and the second identifier of the third wireless device being included in the first frame, the second frame, or a combination thereof. The operations of 1915 may be performed in accordance with examples as disclosed herein. In some examples, aspects of the operations of 1915 may be performed by a data reception component 1630 as described with reference to FIG. 16.

At 1920, the method may include transmitting, to the second wireless device, a second frame including the indication, the indication being associated with the portion of the PPDU. The operations of 1920 may be performed in accordance with examples as disclosed herein. In some examples, aspects of the operations of 1920 may be performed by an indication component 1635 as described with reference to FIG. 16.

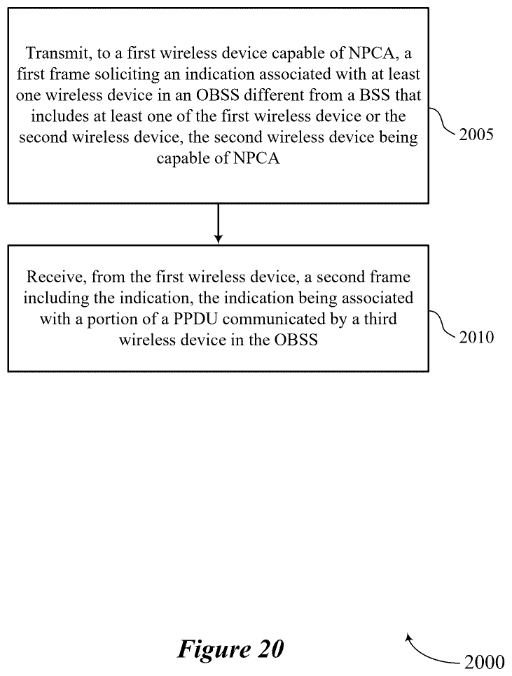

FIG. 20 shows a flowchart illustrating a method 2000 that supports indications for NPCA. The operations of the method 2000 may be implemented by a second wireless device or its components as described herein. For example, the operations of the method 2000 may be performed by a second wireless device as described with reference to FIGS. 1 through 15 and 17. In some examples, a second wireless device may execute a set of instructions to control the functional elements of the second wireless device to perform the described functions. Additionally, or alternatively, the second wireless device may perform aspects of the described functions using special-purpose hardware.

At 2005, the method may include transmitting, to a first wireless device capable of NPCA, a first frame soliciting an indication associated with at least one wireless device in an OBSS different from a BSS that includes at least one of the first wireless device and the second wireless device, the second wireless device being capable of NPCA. The operations of 2005 may be performed in accordance with examples as disclosed herein. In some examples, aspects of the operations of 2005 may be performed by a solicitation manager 1725 as described with reference to FIG. 17.

At 2010, the method may include receiving, from the first wireless device, a second frame including the indication, the indication being associated with a portion of a PPDU communicated by a third wireless device in the OBSS. The operations of 2010 may be performed in accordance with examples as disclosed herein. In some examples, aspects of the operations of 2010 may be performed by an indication manager 1730 as described with reference to FIG. 17.

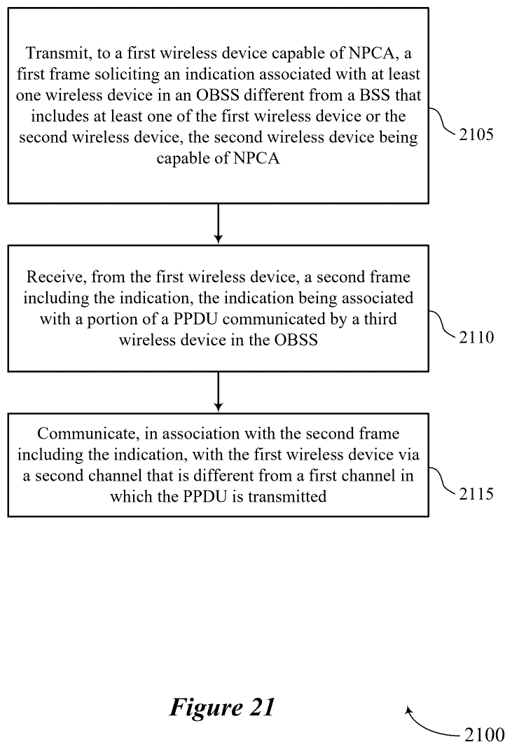

FIG. 21 shows a flowchart illustrating a method 2100 that supports indications for NPCA. The operations of the method 2100 may be implemented by a second wireless device or its components as described herein. For example, the operations of the method 2100 may be performed by a second wireless device as described with reference to FIGS. 1 through 15 and 17. In some examples, a second wireless device may execute a set of instructions to control the functional elements of the second wireless device to perform the described functions. Additionally, or alternatively, the second wireless device may perform aspects of the described functions using special-purpose hardware.

At 2105, the method may include transmitting, to a first wireless device capable of NPCA, a first frame soliciting an indication associated with at least one wireless device in an OBSS different from a BSS that includes at least one of the first wireless device and the second wireless device, the second wireless device being capable of NPCA. The operations of 2105 may be performed in accordance with examples as disclosed herein. In some examples, aspects of the operations of 2105 may be performed by a solicitation manager 1725 as described with reference to FIG. 17.

At 2110, the method may include receiving, from the first wireless device, a second frame including the indication, the indication being associated with a portion of a PPDU communicated by a third wireless device in the OBSS. The operations of 2110 may be performed in accordance with examples as disclosed herein. In some examples, aspects of the operations of 2110 may be performed by an indication manager 1730 as described with reference to FIG. 17.

At 2115, the method may include communicating, in association with the second frame including the indication, with the first wireless device via a second channel that is different from a first channel in which the PPDU is transmitted. The operations of 2115 may be performed in accordance with examples as disclosed herein. In some examples, aspects of the operations of 2115 may be performed by a channel manager 1740 as described with reference to FIG. 17.

In some implementations, one or more of the multiple memories may be configured to store processor-executable code that, when executed, may configure one or more of the multiple processors to perform various functions described herein (as part of a processing system). In some other implementations, the processing system may be pre-configured to perform various functions described herein.

Implementation examples are described in the following numbered clauses:

The following provides an overview of aspects of the present disclosure:

Aspect 1: A method for wireless communication at a first wireless device, comprising: receiving, from a second wireless device capable of NPCA, a first frame soliciting an indication associated with at least one wireless device in an OBSS different from a BSS that includes at least one of the first wireless device and the second wireless device, the first wireless device being capable of NPCA; receiving a portion of a PPDU communicated by a third wireless device, the portion of the PPDU indicating that the third wireless device is included in the OBSS; and transmitting, to the second wireless device, a second frame including the indication, the indication being associated with the portion of the PPDU.

Aspect 2: The method of aspect 1, wherein transmitting the second frame including the indication comprises: transmitting the second frame including the indication via a first channel in which the PPDU is received or via a second channel different from the first channel.

Aspect 3: The method of any of aspects 1 through 2, wherein transmitting the second frame including the indication comprises: transmitting the second frame including the indication via a second link that is different from a first link via which the PPDU is received, the first wireless device being a first MLD and the second wireless device being a second MLD.

Aspect 4: The method of any of aspects 1 through 3, wherein transmitting the second frame including the indication comprises: transmitting the second frame including the indication during a communication of the third wireless device, the communication being associated with the PPDU.

Aspect 5: The method of any of aspects 1 through 3, wherein transmitting the second frame comprises: transmitting the second frame for at least one of: a time solicited by the second wireless device, each time a new OBSS PPDU is detected by the first wireless device in a range from the first wireless device, or a periodic time.

Aspect 6: The method of any of aspects 1 through 5, wherein the indication is limited to one or more wireless devices that communicated one or more respective PPDUs within a time window, including the PPDU communicated by the third wireless device.

Aspect 7: The method of any of aspects 1 through 6, wherein the indication is limited to a type of PPDU, the type of PPDU including the PPDU communicated by the third wireless device.

Aspect 8: The method of aspect 7, wherein the first frame, the second frame, or a combination thereof indicates the type of PPDU.

Aspect 9: The method of any of aspects 1 through 8, wherein a type of PPDU, including the PPDU communicated by the third wireless device, is associated with a capability of the first wireless device, an operation mode of the first wireless device, or a combination thereof.

Aspect 10: The method of any of aspects 1 through 9, wherein the indication comprises a binary value or a non-binary value associated with a measurement of a signal indicating the PPDU, the binary value or the non-binary value being indicated in the first frame, the second frame, or a combination thereof.

Aspect 11: The method of any of aspects 1 through 10, wherein a NFRP trigger frame or a NFRP-like trigger frame variant is used as the first frame, the method further comprising transmitting the second frame if an association identifier (AID) value of the first wireless device is within an AID range.

Aspect 12: The method of any of aspects 1 through 11, further comprising: communicating, with the second wireless device, a mapping between a MAC identifier and a second identifier of the third wireless device, the second identifier being shorter than the MAC identifier, the second identifier of the third wireless device being included in the first frame, the second frame, or a combination thereof.

Aspect 13: The method of any of aspects 1 through 12, wherein the first wireless device is a non-AP STA, the second wireless device is an AP that assigns an AID value to the first wireless device in association with the first wireless device being capable of NPCA, and the first frame is a trigger frame indicating a starting AID value and an AID range, the second frame being transmitted in association with the first wireless device having an AID value within the AID range.

Aspect 14: The method of any of aspects 1 through 13, wherein the first frame soliciting the indication comprises one or more identifiers, at least one of the one or more identifiers being associated with the third wireless device or the PPDU, and the indication being associated with at least one of the one or more identifiers.

Aspect 15: The method of any of aspects 1 through 14, wherein the first frame soliciting the indication is received during a communication associated with the PPDU for identification of the third wireless device or the PPDU.

Aspect 16: The method of any of aspects 1 through 15, wherein the first frame soliciting the indication is addressed to a group of wireless devices including the first wireless device.

Aspect 17: The method of any of aspects 1 through 16, wherein receiving the portion of the PPDU comprises: receiving multiple PPDUs associated with respective third wireless devices, the indication identifying each of the respective third wireless devices.

Aspect 18: A method for wireless communication at a second wireless device, comprising: transmitting, to a first wireless device capable of NPCA, a first frame soliciting an indication associated with at least one wireless device in an OBSS different from a BSS that includes at least one of the first wireless device and the second wireless device, the second wireless device being capable of NPCA; and receiving, from the first wireless device, a second frame including the indication, the indication being associated with a portion of a PPDU communicated by a third wireless device in the OBSS.

Aspect 19: The method of aspect 18, wherein receiving the second frame including the indication comprises: receiving the second frame including the indication via a first channel in which the PPDU is transmitted or via a second channel different from the first channel.

Aspect 20: The method of any of aspects 18 through 19, wherein receiving the second frame including the indication comprises: receiving the second frame including the indication via a second link that is different from a first link via which the PPDU is communicated, the first wireless device being a first MLD and the second wireless device being a second MLD.

Aspect 21: The method of any of aspects 18 through 20, further comprising: transmitting a third frame soliciting another indication in association with a validity of the indication being limited to a time window.

Aspect 22: The method of any of aspects 18 through 21, wherein the indication is limited to a type of PPDU, the type of PPDU including the PPDU communicated by the third wireless device.

Aspect 23: The method of any of aspects 18 through 22, wherein a type of PPDU, including the PPDU communicated by the third wireless device, is associated with a capability of the first wireless device, an operation mode of the first wireless device, or a combination thereof.

Aspect 24: The method of any of aspects 18 through 23, wherein the indication comprises a binary value or a non-binary value associated with a measurement of a signal indicating the PPDU, the binary value or the non-binary value being indicated in the first frame, the second frame, or a combination thereof.

Aspect 25: The method of any of aspects 18 through 24, further comprising: communicating, with the first wireless device, a mapping between a MAC identifier and a second identifier of the third wireless device, the second identifier being shorter than the MAC identifier, the second identifier of the third wireless device being included in the first frame, the second frame, or a combination thereof.

Aspect 26: The method of any of aspects 18 through 25, wherein the first wireless device is a non-AP STA, the second wireless device is an AP that assigns an AID value to the first wireless device in association with the first wireless device being capable of NPCA, and the first frame is a trigger frame indicating a starting AID value and an AID range, the second frame being transmitted in association with the first wireless device having an AID value within the AID range.

Aspect 27: The method of any of aspects 18 through 26, wherein the first frame soliciting the indication is transmitted during a communication associated with the PPDU for identification of the third wireless device or the PPDU.

Aspect 28: The method of any of aspects 18 through 27, further comprising: communicating, in association with the second frame including the indication, with the first wireless device via a second channel that is different from a first channel in which the PPDU is transmitted.

Aspect 29: An apparatus for wireless communication at a first wireless device, comprising one or more memories storing processor-executable code, and one or more processors coupled with the one or more memories and individually or collectively operable to execute the code to cause the first wireless device to perform a method of any of aspects 1 through 17.

Aspect 30: An apparatus for wireless communication at a first wireless device, comprising at least one means for performing a method of any of aspects 1 through 17.

Aspect 31: A non-transitory computer-readable medium storing code for wireless communication, the code comprising instructions executable by one or more processors to perform a method of any of aspects 1 through 17.

Aspect 32: An apparatus for wireless communication at a second wireless device, comprising one or more memories storing processor-executable code, and one or more processors coupled with the one or more memories and individually or collectively operable to execute the code to cause the second wireless device to perform a method of any of aspects 18 through 28.

Aspect 33: An apparatus for wireless communication at a second wireless device, comprising at least one means for performing a method of any of aspects 18 through 28.

Aspect 34: A non-transitory computer-readable medium storing code for wireless communication, the code comprising instructions executable by one or more processors to perform a method of any of aspects 18 through 28.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions also may be physically located at various positions, including being distributed such that portions of functions are implemented at different physical locations. Also, as used herein, including in the claims, “or” as used in a list of items (such as a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrases “based at least in part on,” “associated with”, or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions or information.

As used herein, the term “determine” or “determining” encompasses a wide variety of actions and, therefore, “determining” can include calculating, computing, processing, deriving, investigating, looking up (such as via looking up in a table, a database or another data structure), inferring, ascertaining, measuring, and the like. Also, “determining” can include receiving (such as receiving information), accessing (such as accessing data stored in memory), transmitting (such as transmitting information) and the like. Also, “determining” can include resolving, selecting, obtaining, choosing, establishing and other such similar actions.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. An apparatus for wireless communication at a first wireless device, comprising:
a processing system that includes processor circuitry and memory circuitry that stores code, the processing system configured to cause the first wireless device to:
receive, from a second wireless device capable of non-primary channel access (NPCA), a first frame soliciting an indication associated with at least one wireless device in an overlapping basic service set (OBSS) different from a basic service set (BSS) that includes at least one of the first wireless device and the second wireless device, the first wireless device being capable of NPCA;
receive a portion of a physical layer (PHY) protocol data unit (PPDU) communicated by a third wireless device, the portion of the PPDU indicating that the third wireless device is included in the OBSS; and
transmit, to the second wireless device, a second frame including the indication, the indication being associated with the portion of the PPDU.

2. The apparatus of claim 1, wherein the processing system is configured to cause the first wireless device to:
transmit the second frame including the indication via a first channel in which the PPDU is received or via a second channel different from the first channel.

3. The apparatus of claim 1, wherein the processing system is configured to cause the first wireless device to:
transmit the second frame including the indication via a second link that is different from a first link via which the PPDU is received, the first wireless device being a first multi-link device (MLD) and the second wireless device being a second MLD.

4. The apparatus of claim 1, wherein the processing system is configured to cause the first wireless device to:
transmit the second frame including the indication during a communication of the third wireless device, the communication being associated with the PPDU.

5. The apparatus of claim 1, wherein the processing system is configured to cause the first wireless device to:
transmit the second frame for at least one of: a time solicited by the second wireless device, each time a new OBSS PPDU is detected by the first wireless device in a range from the first wireless device, or a periodic time.

6. The apparatus of claim 1, wherein the indication is limited to one or more wireless devices that communicated one or more respective PPDUs within a time window, including the PPDU communicated by the third wireless device.

7. The apparatus of claim 1, wherein the indication is limited to a type of PPDU, the type of PPDU including the PPDU communicated by the third wireless device.

8. The apparatus of claim 7, wherein the first frame, the second frame, or a combination thereof indicates the type of PPDU.

9. The apparatus of claim 1, wherein a type of PPDU, including the PPDU communicated by the third wireless device, is associated with a capability of the first wireless device, an operation mode of the first wireless device, or a combination thereof.

10. The apparatus of claim 1, wherein the indication comprises a binary value or a non-binary value associated with a measurement of a signal indicating the PPDU, the binary value or the non-binary value being indicated in the first frame, the second frame, or a combination thereof.

11. The apparatus of claim 1, wherein a null data packet (NDP) feedback report poll (NFRP) trigger frame or a NFRP-like trigger frame variant is used as the first frame, and wherein the processing system is further configured to cause the first wireless device to transmit the second frame if an association identifier (AID) value of the first wireless device is within an AID range.

12. The apparatus of claim 1, wherein the processing system is further configured to cause the first wireless device to:
communicate, with the second wireless device, a mapping between a medium access control (MAC) identifier and a second identifier of the third wireless device, the second identifier being shorter than the MAC identifier, the second identifier of the third wireless device being included in the first frame, the second frame, or a combination thereof.

13. A method for wireless communication at a first wireless device, comprising:
receiving, from a second wireless device capable of non-primary channel access (NPCA), a first frame soliciting an indication associated with at least one wireless device in an overlapping basic service set (OBSS) different from a basic service set (BSS) that includes at least one of the first wireless device and the second wireless device, the first wireless device being capable of NPCA;
receiving a portion of a physical layer (PHY) protocol data unit (PPDU) communicated by a third wireless device, the portion of the PPDU indicating that the third wireless device is included in the OBSS; and
transmitting, to the second wireless device, a second frame including the indication, the indication being associated with the portion of the PPDU.

14. The method of claim 13, wherein the first wireless device is a non-access point (AP) station (STA), the second wireless device is an AP that assigns an association identifier (AID) value to the first wireless device in association with the first wireless device being capable of NPCA, and the first frame is a trigger frame indicating a starting AID value and an AID range, the second frame being transmitted in association with the first wireless device having an AID value within the AID range.

15. The method of claim 13, wherein the first frame soliciting the indication comprises one or more identifiers, at least one of the one or more identifiers being associated with the third wireless device or the PPDU, and the indication being associated with at least one of the one or more identifiers.

16. The method of claim 13, wherein the first frame soliciting the indication is received during a communication associated with the PPDU for identification of the third wireless device or the PPDU.

17. The method of claim 13, wherein the first frame soliciting the indication is addressed to a group of wireless devices including the first wireless device.

18. The method of claim 13, wherein:
receiving multiple PPDUs associated with respective third wireless devices, the indication identifying each of the respective third wireless devices.

19. An apparatus for wireless communication at a second wireless device, comprising:
a processing system that includes processor circuitry and memory circuitry that stores code, the processing system configured to cause the second wireless device to:
transmit, to a first wireless device capable of non-primary channel access (NPCA), a first frame soliciting an indication associated with at least one wireless device in an overlapping basic service set (OBSS) different from a basic service set (BSS) that includes at least one of the first wireless device and the second wireless device, the second wireless device being capable of NPCA; and
receive, from the first wireless device, a second frame including the indication, the indication being associated with a portion of a physical layer (PHY) protocol data unit (PPDU) communicated by a third wireless device in the OBSS.

20. The apparatus of claim 19, wherein the processing system is configured to cause the second wireless device to:
receive the second frame including the indication via a first channel in which the PPDU is transmitted or via a second channel different from the first channel.

21. The apparatus of claim 19, wherein the processing system is configured to cause the second wireless device to:
receive the second frame including the indication via a second link that is different from a first link via which the PPDU is communicated, the first wireless device being a first multi-link device (MLD) and the second wireless device being a second MLD.

22. The apparatus of claim 19, wherein the processing system is further configured to cause the second wireless device to:
transmit a third frame soliciting another indication in association with a validity of the indication being limited to a time window.

23. The apparatus of claim 19, wherein the indication is limited to a type of PPDU, the type of PPDU including the PPDU communicated by the third wireless device.

24. The apparatus of claim 19, wherein a type of PPDU, including the PPDU communicated by the third wireless device, is associated with a capability of the first wireless device, an operation mode of the first wireless device, or a combination thereof.

25. The apparatus of claim 19, wherein the indication comprises a binary value or a non-binary value associated with a measurement of a signal indicating the PPDU, the binary value or the non-binary value being indicated in the first frame, the second frame, or a combination thereof.

26. A method for wireless communication at a second wireless device, comprising:
transmitting, to a first wireless device capable of non-primary channel access (NPCA), a first frame soliciting an indication associated with at least one wireless device in an overlapping basic service set (OBSS) different from a basic service set (BSS) that includes at least one of the first wireless device and the second wireless device, the second wireless device being capable of NPCA; and
receiving, from the first wireless device, a second frame including the indication, the indication being associated with a portion of a physical layer (PHY) protocol data unit (PPDU) communicated by a third wireless device in the OBSS.

27. The method of claim 26, further comprising:
communicating, with the first wireless device, a mapping between a medium access control (MAC) identifier and a second identifier of the third wireless device, the second identifier being shorter than the MAC identifier, the second identifier of the third wireless device being included in the first frame, the second frame, or a combination thereof.

28. The method of claim 26, wherein the first wireless device is a non-access point (AP) station (STA), the second wireless device is an AP that assigns an association identifier (AID) value to the first wireless device in association with the first wireless device being capable of NPCA, and the first frame is a trigger frame indicating a starting AID value and an AID range, the second frame being transmitted in association with the first wireless device having an AID value within the AID range.

29. The method of claim 26, wherein the first frame soliciting the indication is transmitted during a communication associated with the PPDU for identification of the third wireless device or the PPDU.

30. The method of claim 26, further comprising:
communicating, in association with the second frame including the indication, with the first wireless device via a second channel that is different from a first channel in which the PPDU is transmitted.
